(19) United States
(12) Patent Application Publication
(10) Pub. No.: US 2021/0179743 A1
(43) Pub. Date: Jun. 17, 2021

(54) LOW AROMATIC POLYOLEFINS

(71) Applicant: ExxonMobil Chemical Patents Inc., Baytown, TX (US)

(72) Inventors: Brian R. Berg, Humble, TX (US); Chelsey M. Broussard, Baytown, TX (US); Chi-I Kuo, Atascocita, TX (US); Porter C. Shannon, Seabrook, TX (US)

(21) Appl. No.: 17/088,286

(22) Filed: Nov. 3, 2020

Related U.S. Application Data
(60) Provisional application No. 62/946,593, filed on Dec. 11, 2019.

(51) Int. Cl. C08F 4/659; C08F 10/02; C08F 2/34; C08F 4/6592

(52) U.S. Cl. CPC C08F 4/65916; C08F 10/02; C08F 2/34; C08F 2410/02; C08F 4/65912; C08F 4/65925; C08F 4/65927; C08F 4/65904

(57) ABSTRACT

The present disclosure relates to processes for producing a catalyst composition. A process may include mixing a catalyst compound having a transition metal atom, an activator, and a support to form a supported catalyst mixture. A process may also include drying the supported catalyst mixture at a pressure of about 10 kPa or less and a temperature of about 60° C. or greater for a period of about 6 h or less. The present disclosure also relates to processes for producing polyolefins. A process may include introducing a catalyst composition and at least one olefin to a polymerization reactor, where the catalyst composition has about 0.5 wt % to about 1.5 wt % aromatic hydrocarbon content, and less than 1 wt % of aliphatic hydrocarbon content. A process may also include obtaining a polyolefin having about 300 ppb or less aromatic hydrocarbon.

### CROSS-REFERENCE TO RELATED APPLICATION

This application claims the benefit of U.S. Provisional Application 62/946,593 filed Dec. 11, 2019 entitled “Low Aromatic Polyolefins”, the entirety of which is incorporated by reference herein.

### FIELD

The present disclosure relates to catalyst compositions, polyolefins, and processes for production of catalyst compositions and polyolefins with low aromatic content.

### BACKGROUND

Polyolefins are widely used commercially because of their robust physical properties. For example, various types of polyethylenes, including high density, low density, and linear low density polyethylenes, are some of the most commercially useful. Polyolefins are typically prepared with a catalyst (mixed with one or more other components to form a catalyst composition) which promotes polymerization of olefin monomers in a reactor, to produce polyolefin polymers.

Improvements in process operability (e.g., sheeting, fouling, etc.) for polyolefin formation have included modifying the catalyst composition by preparing the catalyst composition in different ways. For example, process operability improvements have included: supporting catalysts on inert supports, combining the catalyst composition components (such as activators and supports) in a specific order; manipulating the ratio of the various catalyst composition components; varying the contact time and/or temperature when combining the components of a catalyst composition; and/or combining the catalyst composition with various additives, such as carboxylic acids. It has become typical to prepare a catalyst composition in the presence of a solvent such as toluene because toluene may readily dissolve one or more of the catalyst composition components. For example, it is commonly believed that toluene may interact with the cyclopentadiene ring of a metallocene catalyst to promote dissolution by interactions of the n orbitals of the rings. As a result, toluene was believed to be necessary in the preparation of metallocene catalyst compositions. As such, it is commonly used in the preparation of the metallocene catalyst compositions and in the delivery of the catalyst composition to the polymerization reactor.

However, articles such as films made from polyolefin polymers are often used as plastic packaging for food products. New regulations in various jurisdictions limit the amount of toluene and other non-polyolefin material present in food packaging. Toluene from the preparation of metallocene catalysts is the main source of toluene in polyolefins produced in gas phase processes. There is a need to reduce the use of toluene in catalyst compositions to comply with contemplated regulations on packaging throughout the world.

It was thought that a reduction in the use of toluene in the preparation of catalyst compositions would negatively affect the ability of a catalyst composition to flow into the reactor, or the flowability of the catalyst. Additionally, a reduction in solubility of the catalyst composition might cause reduction in catalyst activity, and/or changes in properties of polyolefins produced, such as molecular weight distribution, comonomer incorporation, production of gels, various physical properties, such as tensile strength, tear strength, and puncture resistance, rheological properties, such as complex viscosity, shear modulus, and loss modulus, or visual properties, such as haze, gloss, and clarity. Consumers typically desire little to no change in the properties of the polyolefins purchased, so that the polyolefins may be used without changes (or with few changes) in the production of consumables and in the utility of the final products. Compliance with regulatory schemes might involve changes to polyolefin production processes, and it would be advantageous if the changes had little to no impact on the consumer.

Therefore, there is a need for polymerization processes, which reduce the amount of aromatic content in a catalyst composition without causing loss of catalyst activity, loss of process continuity, or large changes in the properties of the polyolefin produced.

References for citing in an information disclosure statement pursuant to (37 C.F.R. 1.97(h)) include: U.S. Pat. Nos. 6,608,153; 6,803,430; 7,354,880; U.S. Patent Publication Nos. 2015/0353651; 2018/0273655.

### SUMMARY

The present disclosure relates to processes for producing catalyst compositions. A process may include mixing a catalyst compound having a transition metal atom, an activator, and a support to form a supported catalyst mixture. A process may also include drying the supported catalyst mixture at a pressure of about 10 kPa or less and a temperature of about 60° C. or greater for a period of about 6 h or less.

The present disclosure also relates to catalyst compositions formed by such processes.

Additionally, the present disclosure relates to catalyst compositions including a catalyst compound having a transition metal atom, an aluminum activator, and a support. The catalyst composition may include from about 0.5 wt % to about 1.5 wt % aromatic hydrocarbon and less than 1 wt % of aliphatic hydrocarbon.

The present disclosure also relates to processes for producing polyolefins. A process may include introducing a catalyst composition and at least one olefin to a polymerization reactor, where the catalyst composition has about 0.5 wt % to about 1.5 wt % aromatic hydrocarbon content, and less than 1 wt % of aliphatic hydrocarbon content. A process may also include obtaining a polyolefin having about 300 ppb or less aromatic hydrocarbon.

The present disclosure also relates to polyethylene resins. A polyethylene resin may have a toluene content of about 300 ppb or less, an aluminum content of about 5 ppm or greater, and a silica content of about 50 ppm or greater.

Additionally, the present disclosure relates to polyethylene films having a toluene concentration of about 0.05 mg/m² or less and a weight percent of aluminum of about 0.01 or greater.

### BRIEF DESCRIPTION OF THE DRAWING

FIG. 1 is a graph showing volatiles versus drying time, according to an embodiment.

FIG. 2 is a graph showing catalyst activity against weight percent volatiles, according to an embodiment.

FIG. 3 is a graph comparing complex shear viscosity in pascal seconds versus frequency in radians per second of polyethylene examples according to some embodiments, and comparatives of polyethylenes made using catalysts with higher wt % volatiles, according to an embodiment.

FIG. 4 is a graph comparing viscous modulus in pascals versus elastic modulus in pascals of polyethylene examples according to some embodiments, and comparatives of polyethylenes made using catalysts with higher wt % volatiles.

FIG. 5 is a van Gurp-Palmen Plot comparing phase angles in radians versus absolute values of the complex shear modulus in pascals of polyethylene examples according to some embodiments, and comparatives of polyethylenes made using catalysts with higher wt % volatiles.

FIG. 6 is Four Dimensional Gel-Permeation Chromatograph showing counts versus molecular weight of polyethylene examples according to some embodiments, and comparatives of polyethylenes made using catalysts with higher wt % volatiles.

FIG. 7 is a Four Dimensional Gel-Permeation Chromatograph showing 1-hexene incorporation in weight percent versus molecular weight of polyethylene examples according to some embodiments, and comparatives of polyethylenes made using catalysts with higher wt % volatiles.

FIG. 8 is a graph of a gel count per meter squared versus frequency of finding gels in polyethylene examples according to some embodiments, and comparatives of polyethylenes made using catalysts with higher wt % volatiles.

FIG. 9 is a radar plot comparing an example polyethylene according to one embodiment with a polyethylene made using a catalyst containing higher wt % volatiles.

FIG. 10 is a radar plot comparing an example polyethylene according to one embodiment with a polyethylene made using a catalyst containing higher wt % volatiles.

FIG. 11 is a radar chart comparing an example polyethylene according to one embodiment with a polyethylene made using a catalyst containing higher wt % volatiles.

To facilitate understanding, identical reference numerals have been used, where possible, to designate identical elements or example polymers that are common to multiple figures.

### DETAILED DESCRIPTION

It has been discovered that catalyst compositions may be produced with reduced aromatic content that (1) have similar activity as catalyst compositions having high aromatic content, (2) may be used without process changes or without a loss in process continuity, and/or (3) produce polyolefins with very similar properties to those produced with conventional catalyst compositions having high aromatic content. For example, catalyst compositions including a catalyst, a support and an activator may be combined in the presence of a non-polar solvent including aromatic solvents, and then the aromatics removed under reduced pressure or flow of nitrogen to yield a catalyst composition with low aromatic hydrocarbon content. The catalyst composition may be used to produce polyolefins, also with low aromatic content. The polyolefins with low aromatic hydrocarbon content may be used in food packaging applications.

Embodiments of the present disclosure include methods for preparing a catalyst composition including introducing at least one aromatic hydrocarbon, such as toluene, at least one activator, at least one catalyst having a Group 3 through Group 12 metal atom or lanthanide metal atom to at least one catalyst support to form a first mixture, and reducing the amount of aromatic hydrocarbon to form a catalyst composition having 1 wt % or less of aromatic hydrocarbon based on the total weight of the catalyst composition. The catalyst having a Group 3 through Group 12 metal atom or lanthanide metal atom can be a metallocene catalyst including a Group 4 metal. Aromatic hydrocarbons includes toluene, benzene, ortho-xylene, meta-xylene, para-xylenes, naphthalene, anthracene, phenanthrene, or mixture(s) thereof.

In at least one embodiment, reducing the amount of the aromatic hydrocarbon includes applying heat at about 70° C. or less, such as about 60° C., 50° C., or 40° C. or less, to the first mixture and/or catalyst composition. After reducing the amount of the aromatic hydrocarbon, the catalyst composition can have 0.5 wt % or less of the aromatic hydrocarbon based on the total weight of the catalyst composition, such as about 0 wt % based on the total weight of the catalyst composition.

Embodiments of the present disclosure also include catalyst compositions including a Group 4 metal catalyst including metallocene catalysts, or bis(phenolate) catalysts. Catalyst compositions can further include at least one activator, at least one support material, at least one saturated hydrocarbon, and 1.5 wt % or less of the aromatic hydrocarbon based on the total weight of the catalyst composition. The activator of the catalyst composition can be an alkylalumoxane, such as methylalumoxane.

Drying a catalyst composition to such low wt % of an aromatic hydrocarbon would be expected to change the surface properties (e.g., formation of cracks/crevices) of the catalyst composition, reducing the productivity of the catalyst composition for the polymerization process. It has been discovered that drying does not reduce the productivity or flowability of the catalyst composition for polymerization.

Reduced aromatic hydrocarbon content in the catalyst composition provides polyolefin products having reduced aromatic hydrocarbon content. The polyolefin products may be used as plastic packaging for food products.

### Definitions

For purposes of the present disclosure, the numbering scheme for the Periodic Table Groups is used as described in CHEMICAL AND ENGINEERING NEWS, 63(5), pg. 27 (1985). Therefore, a “Group 4 metal” is an element from group 4 of the Periodic Table, e.g., Hf, Ti, or Zr.

“Catalyst productivity” is a measure of how many grams of polymer (P) are produced using a polymerization catalyst including W g of catalyst (cat), over a period of time of T hours; and may be expressed by the following formula: P/(T×W) and expressed in units of gPgcat⁻¹hr⁻¹. Conversion is the amount of monomer that is converted to polymer product, and is reported as mol % and is calculated based on the polymer yield (weight) and the amount of monomer fed into the reactor. Catalyst activity is a measure of the level of activity of the catalyst and is reported as the mass of product polymer (P) produced per mass of supported catalyst (cat) (gP/g supported cat). In an at least one embodiment, the activity of the catalyst is at least 800 gpolymer/gsupported catalyst/hour, such as about 1,000 or more gpolymer/gsupported catalyst/hour, such as about 2,000 or more gpolymer/gsupported catalyst/hour, such as about 3,000 or more gpolymer/gsupported catalyst/hour, such as about 4,000 or more gpolymer/gsupported catalyst/hour, such as about 5,000 or more gpolymer/gsupported catalyst/hour.

An “olefin,” alternatively referred to as “alkene,” is a linear, branched, or cyclic compound of carbon and hydrogen having at least one double bond. When a polymer or copolymer is referred to as including an olefin, the olefin present in such polymer or copolymer is the polymerized form of the olefin. For example, when a copolymer is described as having an ethylene content of 35 wt % to 55 wt %, it is understood that the monomer (“mer”) unit in the copolymer is derived from ethylene in the polymerization reaction and the derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of “copolymer,” includes terpolymers and the like. An oligomer is typically a polymer having a low molecular weight, such as a Mn of less than less than 2,500 g/mol, or a low number of mer units, such as 75 mer units or less or 50 mer units or less. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on.

A “catalyst composition” is a combination of at least one catalyst and a support material. The catalyst composition may have at least one activator and/or at least one co-activator. When catalyst compositions are described as including neutral stable forms of the components, it is understood that the ionic form of the component is the form that reacts with the monomers to produce polymers. For purposes of the present disclosure, “catalyst composition” includes both neutral and ionic forms of the components of a catalyst composition.

Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

In the present disclosure, the catalyst may be described as a catalyst precursor, a pre-catalyst, catalyst or a transition metal compound, and these terms are used interchangeably. An “anionic ligand” is a negatively charged ligand which donates one or more pairs of electrons to a metal ion. A “neutral donor ligand” is a neutrally charged ligand which donates one or more pairs of electrons to a metal ion.

For purposes of the present disclosure in relation to catalysts, the term “substituted” means that a hydrogen group has been replaced with a hydrocarbyl group, a heteroatom, or a heteroatom containing group. For example, methylcyclopentadiene (MeCp) is a Cp group substituted with a methyl group, ethyl alcohol is an ethyl group substituted with an OH group.

For purposes of the present disclosure, “alkoxides” include those where the alkyl group is a C1 to C10 hydrocarbyl. The alkyl group may be straight chain, branched, or cyclic. The alkyl group may be saturated or unsaturated. In at least one embodiment, the alkyl group may include at least one aromatic group. The term “alkoxy” or “alkoxide” means an alkyl ether or aryl ether radical where the term alkyl is a C1 to C10 alkyl. Examples of suitable alkyl ether radicals include, but are not limited to, methoxy, ethoxy, n-propoxy, iso-propoxy, n-butoxy, iso-butoxy, sec-butoxy, tert-butoxy, phenoxy, and the like.

The present disclosure describes transition metal complexes. The term complex is used to describe molecules in which an ancillary ligand is coordinated to a central transition metal atom. The ligand is stably bonded to the transition metal to maintain its influence during use of the catalyst, such as polymerization. The ligand may be coordinated to the transition metal by covalent bond and/or electron donation coordination or intermediate bonds. The transition metal complexes are typically subjected to activation to perform their polymerization function using an activator, which is believed to create a cation because of the removal of an anionic group, often referred to as a leaving group, from the transition metal.

The terms “hydrocarbyl radical,” “hydrocarbyl,” “hydrocarbyl group,” “alkyl radical,” and “alkyl” are used interchangeably. Likewise, the terms “group”, “radical”, and “substituent” are also used interchangeably. “Hydrocarbyl radical” is defined to be C1-C100 radicals, that may be linear, branched, or cyclic, and when cyclic, aromatic or non-aromatic. Examples of such radicals include, but are not limited to, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted hydrocarbyl radicals are radicals in which at least one hydrogen atom of the hydrocarbyl radical has been substituted with at least a non-hydrogen group, such as halogen (such as Br, Cl, F or I) or at least one functional group such as NR*₂, OR*, SeR*, TeR*, PR*₂, AsR*₂, SbR*₂, SR*, BR*₂, SiR*₃, GeR*₃, SnR*₃, PbR*₃, and the like, or where at least one heteroatom has been inserted within a hydrocarbyl ring.

The term “alkenyl” means a straight chain, branched chain, or cyclic hydrocarbon radical having one or more carbon-carbon double bonds. These alkenyl radicals may be substituted. Examples of suitable alkenyl radicals include, but are not limited to, ethenyl, propenyl, allyl, 1,4-butadienyl, cyclopropenyl, cyclobutenyl, cyclopentenyl, cyclohexenyl, cyclooctenyl and the like including their substituted analogues.

The term “aryl” or “aryl group” means a carbon-containing aromatic ring and the substituted variants thereof, including phenyl, 2-methyl-phenyl, xylyl, or 4-bromo-xylyl. Likewise, heteroaryl means an aryl group where a ring carbon atom (or two or three ring carbon atoms) has been replaced with a heteroatom, such as N, O, or S. The term “aromatic” also refers to pseudoaromatic heterocycles, which are heterocyclic substituents that have similar properties and structures (nearly planar) to aromatic heterocyclic ligands, but are not by definition aromatic; likewise, the term aromatic also refers to substituted aromatics.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. For example, a benzyl group has six ring atoms and tetrahydrofuran has 5 ring atoms. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

In the present disclosure, a catalyst may be described as a catalyst precursor, a pre-catalyst, catalyst or a transition metal compound, and these terms are used interchangeably. A polymerization catalyst composition is a catalyst composition that can polymerize monomers into polymer.

The term “continuous” means a system that operates without interruption or cessation for a period of time. For example, a continuous process to produce a polymer would be one where the reactants are continually introduced into one or more reactors and polymer product is continually withdrawn.

### Catalyst Compounds

In at least one embodiment, the present disclosure provides a catalyst composition including a catalyst having a metal atom. The catalyst can be a metallocene catalyst. The metal can be a Group 3 through Group 12 metal atom, such as Group 3 through Group 10 metal atoms, or lanthanide Group atoms. The catalyst having a Group 3 through Group 12 metal atom can be monodentate or multidentate, such as bidentate, tridentate, or tetradentate, where a heteroatom of the catalyst, such as phosphorous, oxygen, nitrogen, or sulfur is chelated to the metal atom of the catalyst. Non-limiting examples include bis(phenolate)s. In at least one embodiment, the Group 3 through Group 12 metal atom is selected from Group 5, Group 6, Group 8, or Group 10 metal atoms. In at least one embodiment, a Group 3 through Group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from Groups 4, 5, and 6 metal atoms. In at least one embodiment, a metal atom is a Group 4 metal atom selected from Ti, Zr, or Hf. The oxidation state of the metal atom can range from 0 to +7, for example +1, +2, +3, +4, or +5, for example +2, +3 or +4.

A catalyst of the present disclosure can be a chromium or chromium-based catalyst. Chromium-based catalysts include chromium oxide (CrO₃) and silylchromate catalysts. Chromium catalysts have been the subject of much development in the area of continuous fluidized-bed gas-phase polymerization for the production of polyethylene polymers. Such catalysts and polymerization processes have been described, for example, in U.S. Publication No. 2011/0010938 and U.S. Pat. Nos. 7,915,357; 8,129,484; 7,202,313; 6,833,417; 6,841,630; 6,989,344; 7,504,463; 7,563,851; 8,420,754; and 8,101,691.

Metallocene catalysts include metallocenes including Group 3 to Group 12 metal complexes, such as, Group 4 to Group 6 metal complexes, or Group 4 metal complexes. The metallocene catalyst of the catalyst compositions of the present disclosure may be unbridged metallocene catalysts represented by the formula: Cp^{A}Cp^{B}M′X′ₙ, where each Cp^{A} and Cp^{B} is independently selected from cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, cyclopentaphenanthrenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

The metallocene catalyst may be a bridged metallocene catalyst represented by the formula: Cp^{A}(A)Cp^{B}M′X′ₙ, where each Cp^{A} and Cp^{B} is independently selected from cyclopentadienyl ligands and ligands isolobal to cyclopentadienyl. One or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. (A) is selected from divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, n-propylcyclopentadienyl, indenyl, pentamethylcyclopentadienyl, tetramethylcyclopentadienyl, and n-butylcyclopentadienyl. (A) may also be O, S, NR′, or SiR′₂, where each R′ is independently hydrogen or C1-C20 hydrocarbyl.

In another embodiment, the metallocene catalyst is represented by the formula:

T_{y}CpₘMGₙX_{q},

where Cp is independently a substituted or unsubstituted cyclopentadienyl ligand or substituted or unsubstituted ligand isolobal to cyclopentadienyl. M is a Group 4 transition metal. G is a heteroatom group represented by the formula JR*_{z} where J is N, P, O, or S, and R* is a linear, branched, or cyclic C1-C20 hydrocarbyl. z is 1 or 2. T is a bridging group. y is 0 or 1. X is a leaving group. m=1, n=1, 2, or 3, q=0, 1, 2, or 3, and the sum of m+n+q is equal to the oxidation state of the transition metal.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof.

The metallocene catalyst compound may be selected from:
bis(1-methyl, 3-n-butyl cyclopentadienyl) zirconium dichloride;
dimethylsilyl bis(tetrahydroindenyl) zirconium dichloride;
bis(n-propylcyclopentadienyl) hafnium dimethyl;
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C(tetramethylcyclopentadienyl)(1-cyclododecylamido)M(R)₂;
μ-(CH₃)₂Si(η⁵-2,6,6-trimethyl-1,5,6,7-tetrahydro-s-indacen-1-yl)(tertbutylamido)M(R)₂;
   where M is selected from Ti, Zr, and Hf; and R is selected from halogen or C1 to C5 alkyl.

In at least one embodiment, the catalyst compound is a bis(phenolate) catalyst compound represented by Formula (I):

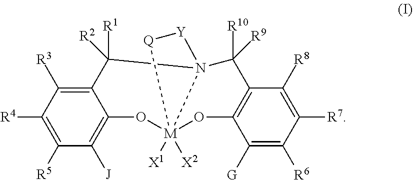

M is a Group 4 metal. X¹ and X² are independently a univalent C1-C20 hydrocarbyl, C1-C20 substituted hydrocarbyl, a heteroatom or a heteroatom-containing group, or X¹ and X² join together to form a C4-C62 cyclic or polycyclic ring structure. R¹, R², R³, R⁴, R⁵, R⁶, R⁷, R⁸, R⁹, and R¹⁰ is independently hydrogen, C1-C40 hydrocarbyl, C1-C40 substituted hydrocarbyl, a heteroatom or a heteroatom-containing group, or two or more of R, R², R³, R⁴, R⁵, R⁶, R⁷, R⁸, R⁹, or R¹⁰ are joined together to form a C4-C62 cyclic or polycyclic ring structure, or a combination thereof. Q is a neutral donor group. J is heterocycle, a substituted or unsubstituted C7-C60 fused polycyclic group, where at least one ring is aromatic and where at least one ring, which may or may not be aromatic, has at least five ring atoms. G is as defined for J or may be hydrogen, C2-C60 hydrocarbyl, C1-C60 substituted hydrocarbyl, or may independently form a C4-C60 cyclic or polycyclic ring structure with R⁶, R⁷, or R⁸ or a combination thereof. Y is divalent C1-C20 hydrocarbyl or divalent C1-C20 substituted hydrocarbyl or (—Q*—Y—) together form a heterocycle. Heterocycle may be aromatic and/or may have multiple fused rings.

In at least one embodiment, the catalyst represented by Formula (I) is:

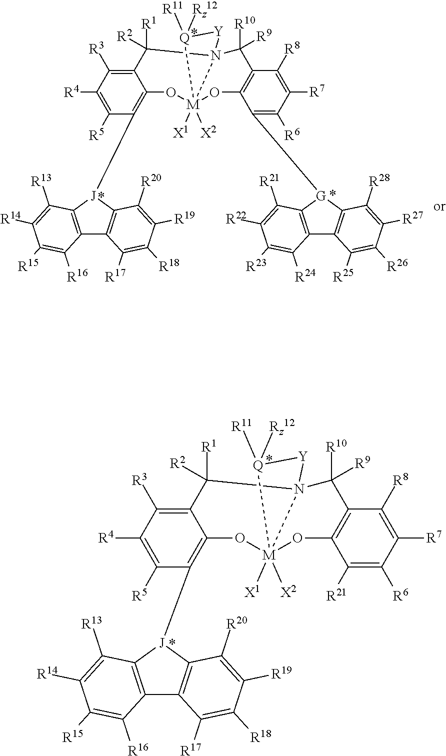

M is Hf, Zr, or Ti. X¹, X², R¹, R², R³, R⁴, R⁵, R⁶, R⁷, R⁸, R⁹, R¹⁰, and Y are as defined for Formula (I). R, R¹³, R¹⁴, R¹⁵, R¹⁶, R¹⁷, R⁸, R¹⁹, R²⁰, R²¹, R²², R²³, R²⁴, R²⁵, R²⁶, R²⁷, and R²⁸ is independently a hydrogen, C1-C40 hydrocarbyl, C1-C40 substituted hydrocarbyl, a functional group including elements from Groups 13 to 17, or two or more of R, R², R³, R⁴, R⁵, R⁶, R⁷, R⁸, R⁹, R¹⁰ R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ may independently join together to form a C4-C62 cyclic or polycyclic ring structure, or a combination thereof. R¹¹ and R¹² may join together to form a five- to eight-membered heterocycle. Q* is a group 15 or 16 atom. z is 0 or 1. J* is CR″ or N, and G* is CR″ or N, where R″ is C1-C20 hydrocarbyl or carbonyl-containing C1-C20 hydrocarbyl. z=0 if Q* is a group 16 atom, and z=1 if Q* is a group 15 atom.

In at least one embodiment, the first catalyst represented by Formula (I) is:

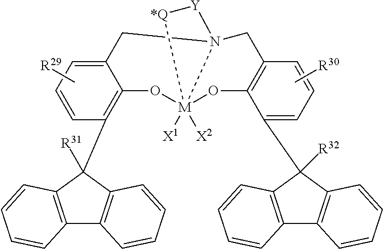

Y is a divalent C1-C3 hydrocarbyl. Q* is NR₂, OR, SR, PR₂, where R is as defined for R¹ represented by Formula (I). M is Zr, Hf, or Ti. X¹ and X² is independently as defined for Formula (I). R²⁹ and R³⁹ is independently C1-C40 hydrocarbyl. R³¹ and R³² is independently linear C1-C20 hydrocarbyl, benzyl, or tolyl.

Catalyst compositions of the present disclosure may include a second catalyst having a Group 3 through Group 12 metal atom or lanthanide metal atom and having a chemical structure different than the first catalyst of the catalyst composition. For purposes of the present disclosure one catalyst is considered different from another if they differ by at least one atom. For example “bisindenyl zirconium dichloride” is different from (indenyl)(2-methylindenyl) zirconium dichloride” which is different from “(indenyl)(2-methylindenyl) hafnium dichloride.” Catalysts that differ only by isomer are considered the same for purposes of this disclosure, e.g., rac-dimethylsilylbis(2-methyl 4-phenyl)hafnium dimethyl is considered to be the same as meso-dimethylsilylbis(2-methyl 4-phenyl)hafnium dimethyl.

In at least one embodiment, two or more different catalysts are present in the catalyst composition. In at least one embodiment, two or more different catalysts are present in the reaction zone. When two transition metal catalysts are used in one reactor as a mixed catalyst composition, the two transition metal compounds may be chosen such that the two are compatible. A suitable screening method, such as by ¹H or ¹³C NMR, can be used to determine which transition metal compounds are compatible. In some embodiments, the same activator is used for the transition metal compounds; however, two different activators, such as a non-coordinating anion activator and an alumoxane, may be used in combination. If one or more transition metal compounds contain an X¹ or X² ligand which is not a hydride, hydrocarbyl, or substituted hydrocarbyl, then the alumoxane may be contacted with the transition metal compounds prior to addition of the non-coordinating anion activator.

The first catalyst and the second catalyst may be used in any suitable ratio (A:B). The first catalyst may be (A) if the second catalyst is (B). Alternatively, the first catalyst may be (B) if the second catalyst is (A). Suitable molar ratios of (A) transition metal compound to (B) transition metal compound include the ratio (A:B) from about 1:1000 to about 1000:1, such as from about 1:100 to about 500:1, from about 1:10 to about 200:1, from about 1:1 to about 100:1, from about 1:1 to about 75:1, or about 5:1 to about 50:1. The ratio chosen will depend on the exact catalysts chosen, the method of activation, and the product desired. In some embodiments, when using the two catalysts, where both are activated with the same activator, useful mole percents, based upon the molecular weight of the catalysts, are from about 10 to about 99.9% of (A) to about 0.1 to about 90% of (B), such as from about 25 to about 99% (A) to about 0.5 to about 50% (B), such as from about 50 to about 99% (A) to about 1 to about 25% (B), such as from about 75 to about 99% (A) to about 1 to about 10% (B).

### Activators

Catalyst compositions of the present disclosure may be formed by combining the above catalysts with activators in any suitable manner known from the literature including by supporting the catalysts for use in slurry or gas phase polymerization. Activators are defined to be a compound which can activate one of the catalysts described above by converting the neutral metal compound to a catalytically active metal compound cation. Non-limiting activators, for example, include alumoxanes, aluminum alkyls, ionizing activators, which may be neutral or ionic and other cocatalysts. In some embodiments, activators include alumoxane compounds, modified alumoxane compounds, and ionizing anion precursor compounds that abstract a reactive, G-bound, metal ligand making the metal compound cationic and providing a charge-balancing noncoordinating or weakly coordinating anion.

Non-limiting species of noncoordinating or weakly coordinating anion activator include N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetra(perfluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-diethylanilinium tetrakis(perfluoronaphthyl)borate, N,N-dimethyl-(2,4,6-trimethylanilinium) tetrakis(perfluoronaphthyl)borate, and tropillium tetrakis(perfluoronaphthyl)borate.

In at least one embodiment, the activator is represented by the formula:

(Z)_{d}⁺(A^{d-})

where Z is (L-H) or a reducible Lewis Acid, L is an neutral Lewis base, and H is hydrogen. (L-H)⁺ is a Brsnsted acid. A^{d-} is a non-coordinating anion having the charge d− and d is an integer from 1 to 3. In at least one embodiment, Z is a reducible Lewis acid represented by the formula: (Ar₃C⁺), where Ar is aryl or aryl substituted with a heteroatom, a C1 to C40 hydrocarbyl, or a substituted C1 to C40 hydrocarbyl.

When Z_{d}⁺ is the activating cation (L−H)_{d}⁺, it can be a Brsnsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether diethyl ether, tetrahydrofuran and dioxane, sulfoniums from thioethers, such as diethyl thioethers, tetrahydrothiophene, and mixtures thereof.

### Alumoxane Activators

Alumoxane activators are utilized as activators in the catalyst compositions described. Alumoxanes are typically oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes may be suitable as catalyst activators when the abstractable ligand is an alkyl, halide, alkoxide or amide. Mixtures of different alumoxanes and modified alumoxanes may also be used. A visually clear methylalumoxane may be used. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

When the activator is an alumoxane (modified or unmodified), the amount of activator may include up to a 5000-fold molar excess (Al/M) over the catalyst compound (per metal catalytic site). The activator to catalyst compound molar ratio is about 1 or greater. Suitable ratios may include from 1:1 to 500:1, such as from 1:1 to 200:1, from 1:1 to 100:1, or from 1:1 to 50:1. In an alternative embodiment, little or no alumoxane is used in the polymerization processes described. In some embodiments, alumoxane is present at zero mol %.

### Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause the cation to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Ionizing activators typically include an NCA, such as a compatible NCA.

It is within the scope of the present disclosure to use an ionizing activator, neutral or ionic, such as tri (n-butyl) ammonium tetrakis (pentafluorophenyl) borate, a tris perfluorophenyl boron metalloid precursor or a tris perfluoronaphthyl boron metalloid precursor, polyhalogenated heteroborane anions (WO 98/43983), boric acid (U.S. Pat. No. 5,942,459), or combination thereof. It is also within the scope of the present disclosure to use neutral or ionic activators alone or in combination with alumoxane or modified alumoxane activators. For descriptions of useful activators please see U.S. Pat. Nos. 8,658,556 and 6,211,105.

In some embodiments, the activator is selected from: N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻], 1-(4-(tris(pentafluorophenyl)borate)-2,3,5,6-tetrafluorophenyl)pyrrolidinium, tetrakis(pentafluorophenyl)borate, and 4-(tris(pentafluorophenyl)borate)-2,3,5,6-tetrafluoropyridine.

In some embodiments, the activator includes a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate).

In another embodiment, the activator includes one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(iso-propyl)ammonium tetrakis(pentafluorophenyl)borate, (where alkyl is methyl, ethyl, propyl, n-butyl, sec-butyl, or t-butyl).

The typical activator to catalyst molar ratio, e.g., combine moles of activators to moles of catalyst is about 1:1. Alternatively, activator to catalyst molar ratio may be from 0.1:1 to 100:1, such as from 0.5:1 to 200:1, from 1:1 to 500:1, or from 1:1 to 1000:1. In some embodiments, the activator to catalyst molar ratio is from 0.5:1 to 10:1, such as 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0573120B1; WO 94/07928; and WO 95/14044 (the disclosures of which are incorporated by reference) which discuss the use of an alumoxane in combination with an ionizing activator).

### Optional Scavengers, Co-Activators, Chain Transfer Agents

In addition to these activator compounds, catalyst compositions of the present disclosure may include scavengers or co-activators. Scavengers or co-activators include aluminum alkyl or organoaluminum compounds, for example, trimethylaluminum, triethylaluminum, triisobutylaluminum, tri-n-hexylaluminum, tri-n-octylaluminum, and diethyl zinc.

Chain transfer agents may be used in the compositions and/or processes described. Useful chain transfer agents are typically alkylalumoxanes, a compound represented by the formula AiR₃, ZnR₂ (where each R is, independently, a C1-C8 aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

### Support Materials

The catalyst composition includes an inert support material. The supported material may be a porous support material, for example, talc, and inorganic oxides. Other support materials include zeolites, clays, organoclays, or other organic or inorganic support material and the like, or mixtures thereof.

In at least one embodiment, the support material is an inorganic oxide in a finely divided form. Suitable inorganic oxide materials for use in catalyst compositions include Groups 2, 4, 13, and 14 metal oxides, such as silica, alumina, silica-alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Supports may also include magnesia, titania, zirconia, montmorillonite, phyllosilicate, zeolites, talc, clays, silica clay, silicon oxide clay, and the like. Also, combinations of these support materials may be used, for example, silica-chromium, silica-alumina, silica-titania, and the like. In at least one embodiment, the support material is selected from Al₂O₃, ZrO₂, SiO₂, SiO₂/Al₂O₂, silica clay, silicon oxide/clay, or mixtures thereof.

The support material may be fluorided. The phrases “fluorided support” and “fluorided support composition” mean a support, desirably particulate and porous, which has been treated with at least one inorganic fluorine containing compound. For example, the fluorided support composition can be a silicon dioxide support where a portion of the silica hydroxyl groups has been replaced with fluorine or fluorine containing compounds. Suitable fluorine containing compounds include, but are not limited to, inorganic fluorine containing compounds and/or organic fluorine containing compounds.

Fluorine compounds suitable for providing fluorine for the support may be organic or inorganic fluorine compounds and are desirably inorganic fluorine containing compounds. Such inorganic fluorine containing compounds may be a compound containing a fluorine atom as long as the compound does not contain a carbon atom. Suitable inorganic fluorine-containing compounds may be selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, NHF₂, NH₄HF₂, and combinations thereof. In at least one embodiment, ammonium hexafluorosilicate and ammonium tetrafluoroborate are used.

The support material, such as an inorganic oxide, can have a surface area of from about 10 to about 700 m²/g, pore volume of from about 0.1 to about 4 cc/g and average particle size of from about 5 to about 500 μm. Furthermore, the surface area of the support material can be, for example, from about 50 m²/g to about 500 m²/g, pore volume of from about 0.5 cc/g to about 3.5 cc/g and average particle size of from about 10 μm to about 200 μm. The surface area of the support material can further be from about 100 m²/g to about 400 m²/g, pore volume from about 0.8 cc/g to about 3 cc/g and average particle size is from about 5 μm to about 100 μm. For purposes of the present disclosure, the average pore size of the support material can be from 10 Å to 1000 Å, such as 50 Å to about 500 Å, such as 75 Å to about 350 Å. In at least one embodiment, the support material is a high surface area, amorphous silica (surface area=300 m²/gm; pore volume of 1.65 cm³/gm). Suitable silicas are marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pa.) that has been calcined (such as at 875° C.), for example.

The support material should be dry, that is, free of absorbed water. Drying of the support material can be effected by heating or calcining at about 100° C. to about 1000° C., such as at least about 600° C. When the support material is silica, the support material is heated to at least 200° C., such as about 200° C. to about 850° C., such as at about 600° C.; and for a time of about 1 minute to about 100 hours, from about 12 hours to about 72 hours, or from about 24 hours to about 60 hours. The calcined support material can have at least some reactive hydroxyl (OH) groups to produce supported catalyst compositions of the present disclosure. The calcined support material is then contacted with at least one polymerization catalyst including at least one catalyst compound and an activator.

### Catalyst Composition Formation

Methods for preparing a catalyst composition including introducing at least one aromatic hydrocarbon, at least one activator, at least one catalyst having a Group 3 through Group 12 metal atom or lanthanide metal atom, to at least one catalyst support to form a first mixture, reducing the amount of the aromatic hydrocarbon to form a catalyst composition having about 1.5 wt % or less of aromatic hydrocarbon based on the total weight of the catalyst composition. The catalyst having a Group 3 through Group 12 metal atom or lanthanide metal atom can be a metallocene catalyst including a Group 4 metal.

The support material may be slurried in a non-polar solvent including aromatic hydrocarbon and the resulting slurry contacted with a solution of a catalyst compound and an activator. In at least one embodiment, the slurry of the support material is first contacted with the activator for a period of time from about 0.5 hours to about 24 hours, from about 2 hours to about 16 hours, or from about 4 hours to about 8 hours. A solution of the catalyst compound is then contacted with the isolated support/activator. In some embodiments, the supported catalyst composition is generated in situ. In alternative embodiments, the slurry of the support material is first contacted with the catalyst compound for a period of time from about 0.5 hours to about 24 hours, from about 2 hours to about 16 hours, or from about 4 hours to about 8 hours and then the slurry of the supported catalyst compound is introduced to an activator solution.

Suitable non-polar solvents are materials in which the activator, and the catalyst, are at least partially soluble and which are liquid at reaction temperatures. Suitable non-polar solvents are alkanes, such as isopentane, hexane, n-heptane, octane, nonane, and decane, although a variety of other materials including cycloalkanes, such as cyclohexane, may be employed. Non-polar solvents include aromatic hydrocarbons, such as benzene, toluene, and ethylbenzene. In some embodiments, a mixture of non-polar solvents is employed, such as a mixture of toluene and ethylbenzene.

The mixture of the catalyst, activator, support, and solvent is heated to about 0° C. to about 70° C., such as about 23° C. to about 60° C., such as at room temperature. Contact times typically range from about 0.5 hours to about 24 hours, from about 2 hours to about 16 hours, or from about 4 hours to about 8 hours.

After the contact time and/or heating, the amount of aromatic hydrocarbons is reduced in the mixture of the catalyst, activator, and support to form the catalyst composition. Removing aromatic hydrocarbon dries the mixture and may be performed under a vacuum atmosphere, purge with inert atmosphere, heating of the mixture, or combination(s) thereof. For heating of the mixture, a temperature can be used that evaporates aromatic hydrocarbon. Reduced pressure (under vacuum) lowers the boiling point of aromatic hydrocarbons, which is dependent on the pressure of the reactor. Reduction of aromatic hydrocarbon may take place at temperatures from about 10° C. to about 200° C., such as from about 25° C. to about 140° C., about 50° C. to about 120° C., about 60° C. to about 80° C., about 65° C. to about 75° C., or about 70° C. In some embodiments, reducing the amount of aromatic hydrocarbon includes applying heat at about 25° C. or more, such as about 50° C. or more, about 55° C. or more, about 60° C. or more, or about 65° C. or more. In at least one embodiment, removing toluene includes applying heat, applying vacuum, and applying nitrogen purged from the bottom of the vessel by bubbling nitrogen through the mixture.

The reduction of aromatic hydrocarbon may take place at atmospheric pressure or less, such as a pressure of 100 kPa or less, 50 kPa or less, 10 kPa or less, 5 kPa or less, 2 kPa or less, 1 kPa or less, 0.4 kPa or less, or 0.2 kPa or less. The reduction in aromatic hydrocarbon may take place for a time period of about 5 minutes or more, such as from about 5 minutes to about 96 hours, from about 10 minutes to about 72 hours, from about 20 minutes to about 48 hours, from about 30 minutes to about 24 hours, or from about 1 hour to about 20 hours. In some embodiments, the reduction in aromatic hydrocarbon takes place for a time period of about 10 hours or less, such as about 9 hours or less, about 8 hours or less, about 7 hours or less, such as about 6 hours or less, about 5 hours or less, or about 4 hours or less. After reducing the amount of aromatic hydrocarbon, the catalyst composition can have 1.5 wt % or less aromatic hydrocarbon based on the total weight of the catalyst composition, such as about 1.4 wt % or less, 1.3 wt % or less, 1.2 wt % or less, 1.1 wt % or less, 1 wt % or less, 0.9 wt % or less, 0.8 wt % or less, 0.7 wt % or less, 0.6 wt % or less, 0.5 wt % or less, 0.4 wt % or less, 0.3 wt % or less, 0.2 wt % or less, 0.1 wt % or less, 0.01 wt % or less, or substantially no aromatic hydrocarbon, based on the total weight of the catalyst composition. In some embodiments, toluene is used as the solvent for forming the catalyst composition and is reduced as part of the reduction of aromatic hydrocarbon. For example, the catalyst composition can have 1.5 wt % or less toluene based on the total weight of the catalyst composition, such as about 1.4 wt % or less, 1.3 wt % or less, 1.2 wt % or less, 1.1 wt % or less, 1 wt % or less, 0.9 wt % or less, 0.8 wt % or less, 0.7 wt % or less, 0.6 wt % or less, 0.5 wt % or less, 0.4 wt % or less, 0.3 wt % or less, 0.2 wt % or less, 0.1 wt % or less, 0.01 wt % or less, or substantially no toluene, based on the total weight of the catalyst composition.

In some embodiments, the catalyst composition has residual aromatic hydrocarbon (e.g., toluene) that is not removed during the reduction of aromatic hydrocarbon. After reducing the amount of aromatic hydrocarbon, the catalyst composition can have 0.01 wt % or more aromatic hydrocarbon based on the total weight of the catalyst composition, such as about 0.1 wt % or more, 0.2 wt % or more, 0.3 wt % or more, 0.4 wt % or more, 0.5 wt % or more, 0.6 wt % or more, 0.7 wt % or more, 0.8 wt % or more, 0.9 wt % or more, 1.0 wt % or more, 1.1 wt % or more, or 1.2 wt % or more, based on the total weight of the catalyst composition. In some embodiments, toluene is used as the solvent for forming the catalyst composition and is reduced as part of the reduction of aromatic hydrocarbon. For example, the catalyst composition can have 0.01 wt % or more toluene based on the total weight of the catalyst composition, such as about 0.1 wt % or more, 0.2 wt % or more, 0.3 wt % or more, 0.4 wt % or more, 0.5 wt % or more, 0.6 wt % or more, 0.7 wt % or more, 0.8 wt % or more, 0.9 wt % or more, 1.0 wt % or more, 1.1 wt % or more, or 1.2 wt % or more, based on the total weight of the catalyst composition.

Additionally, after reducing the amount of aromatic hydrocarbon, other volatiles may also be reduced, such as aliphatic hydrocarbons, and/or solvent, therefore, the catalyst composition can have 1.5 wt % or less aliphatic hydrocarbon based on the total weight of the catalyst composition, such as about 1.4 wt % or less, 1.3 wt % or less, 1.2 wt % or less, 1.1 wt % or less, 1 wt % or less, 0.9 wt % or less, 0.8 wt % or less, 0.7 wt % or less, 0.6 wt % or less, 0.5 wt % or less, 0.4 wt % or less, 0.3 wt % or less, 0.2 wt % or less, 0.1 wt % or less, 0.01 wt % or less, or substantially no aliphatic hydrocarbon, based on the total weight of the catalyst composition. The reduction of both aliphatic and aromatic hydrocarbon produces a catalyst composition with low overall hydrocarbon content, for example, the catalyst composition can have 1.5 wt % or less hydrocarbon content based on the total weight of the catalyst composition, such as about 1.4 wt % or less, 1.3 wt % or less, 1.2 wt % or less, 1.1 wt % or less, 1 wt % or less, 0.9 wt % or less, 0.8 wt % or less, 0.7 wt % or less, 0.6 wt % or less, 0.5 wt % or less, 0.4 wt % or less, 0.3 wt % or less, 0.2 wt % or less, 0.1 wt % or less, 0.01 wt % or less, or substantially no hydrocarbon content, based on the total weight of the catalyst composition.

In some embodiments, the batch size is from about 50 grams of catalyst to about 150 grams of catalyst, such as from about 90 grams of catalyst to about 110 grams of catalyst, for example about 100 grams of catalyst. A reduction of aromatic hydrocarbon content for a larger batch size may take place for longer periods of time, under reduced pressure, and/or at higher temperatures. Additionally or alternatively, the aromatic hydrocarbon content of a catalyst composition of a batch size of 100 g may be reduced at a temperature of about 60° C. to about 80° C., at a pressure of about 2 kPa or less, for about 3 hours or less.

### Polymerization Processes

In at least one embodiment of the present disclosure, a method includes polymerizing olefins to produce a polyolefin composition by introducing at least one olefin to a catalyst composition of the present disclosure and obtaining the polyolefin composition. For example, a catalyst composition having low aromatic hydrocarbon content (and low overall hydrocarbon content) can have sufficient flowability such that it can be introduced into a reactor. Polymerization may be conducted at a temperature of from about 0° C. to about 300° C., at a pressure from about 0.35 MPa to about 10 MPa, and/or at a time up to about 300 minutes.

Embodiments of the present disclosure include polymerization processes where monomer (such as ethylene or propylene), and optionally comonomer, are contacted with a catalyst composition including at least one catalyst and an activator, as described above. The at least one catalyst and activator may be combined in any suitable order, and are combined typically prior to contact with the monomer.

Monomers may include substituted or unsubstituted C2 to C40 alpha olefins, such as C2 to C20 alpha olefins, or C2 to C12 alpha olefins. In some embodiments, the monomers are selected from ethylene, propylene, butene, pentene, hexene, heptene, octene, nonene, decene, undecene, dodecene, isomers thereof, or mixture(s) thereof. In at least one embodiment, olefins include a monomer that is ethylene and one or more optional comonomers including one or more ethylene or C4 to C40 olefin, such as a C4 to C20 olefin, or a C6 to C12 olefin. The olefin monomers may be linear, branched, or cyclic. The olefin monomers may be strained or unstrained, monocyclic or polycyclic, and may include one or more heteroatoms and/or one or more functional groups.

Exemplary C2 to C40 olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and substituted derivatives thereof.

In at least one embodiment, one or more dienes are present in polymers produced at about 10 wt % or less, such as from about 0.00001 to about 1.0 wt %, such as from about 0.002 to about 0.5 wt %, such as from about 0.003 to about 0.2 wt %, based upon the total weight of the composition. In at least one embodiment, about 500 ppm or less of diene is added to the polymerization, such as about 400 ppm or less, such as about 300 ppm or less. In at least one embodiment, at least about 50 ppm of diene is added to the polymerization, or about 100 ppm or more, or 150 ppm or more.

Diolefin monomers include a hydrocarbon structure, such as a C4 to C30 hydrocarbon, having at least two unsaturated bonds, where at least two of the unsaturated bonds are readily incorporated into a polymer by either a stereospecific or a non-stereospecific catalyst(s). The diolefin monomers can be selected from alpha, omega-diene monomers (i.e., di-vinyl monomers). The diolefin monomers can be linear di-vinyl monomers, such as those containing from 4 to 30 carbon atoms. Non-limiting examples of suitable dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, or combination(s) thereof. In some embodiments, dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Non-limiting examples of suitable cyclic dienes include cyclopentadiene, vinylnorbornene, norbornadiene, ethylidene norbornene, divinylbenzene, dicyclopentadiene or higher ring containing diolefins with or without substituents at various ring positions.

Polymerization processes of the present disclosure can be carried out in any suitable manner. A slurry, and/or gas phase polymerization process can be used. Such processes can be run in a batch, semi-batch, or continuous mode. In some embodiments, no solvent or diluent is present or added in the reaction medium. In some embodiments, the reaction medium includes condensing agents, which are typically non-coordinating inert liquids that are converted to gas in the polymerization processes, such as isopentane, isohexane, or isobutane. In some embodiments, the process is a slurry process. The term “slurry polymerization process” means a polymerization process where a supported catalyst is used and monomers are polymerized on the supported catalyst particles. At least 95 wt % of polymer products derived from the supported catalyst are in granular form as solid particles (not dissolved in the diluent). Methods of the present disclosure may include introducing the catalyst composition into a reactor as a slurry.

Suitable condensing agents/diluents/solvents for polymerization include non-coordinating, inert liquids. Non-limiting examples include straight and branched-chain hydrocarbons, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); or perhalogenated hydrocarbons, such as perfluorinated C4 to C10 alkanes. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexane, isohexane, heptane, octane, dodecane, or mixtures thereof; cyclic and alicyclic hydrocarbons, such as cyclohexane, cycloheptane, methylcyclohexane, methylcycloheptane, or mixtures thereof. In some embodiments, the solvent is not aromatic, and aromatics are present in the solvent at less than about 1 wt %, such as less than about 0.5 wt %, such as about 0 wt % based upon the weight of the solvents.

In at least one embodiment, the feed concentration of the monomers and comonomers for the polymerization is about 60 vol % solvent or less, such as about 40 vol % or less, or about 20 vol % or less, based on the total volume of the feedstream. In at least one embodiment, the polymerization is run in a bulk process.

Polymerizations can be run at a temperature and/or pressure suitable to obtain the desired polyolefins. Suitable temperatures and/or pressures include a temperature from about 0° C. to about 300° C., such as from about 20° C. to about 200° C., such as from about 35° C. to about 150° C., such as from about 40° C. to about 120° C., such as from about 45° C. to about 80° C.; and at a pressure from about 0.35 MPa to about 10 MPa, such as from about 0.45 MPa to about 6 MPa, or from about 0.5 MPa to about 4 MPa.

In a typical polymerization, the run time of the reaction can be up to about 300 minutes, such as from about 5 to about 250 minutes, or from about 10 to about 120 minutes. In a continuous process the run time may be the average residence time of the reactor.

Hydrogen may be added to a reactor for molecular weight control of polyolefins. In at least one embodiment, hydrogen is present in the polymerization reactor at a partial pressure of from about 0.001 and 50 psig (0.007 to 345 kPa), such as from about 0.01 to about 25 psig (0.07 to 172 kPa), such as from about 0.1 and 10 psig (0.7 to 70 kPa). In at least one embodiment, 600 ppm or less of hydrogen is added, or 500 ppm or less of hydrogen is added, or 400 ppm or less or 300 ppm or less. In other embodiments, at least 50 ppm of hydrogen is added, such as 100 ppm or more, or 150 ppm or more.

In an alternative embodiment, the activity of the catalyst is at least about 50 g/mmol/hour, such as about 500 or more g/mmol/hour, such as about 5,000 or more g/mmol/hr, such as about 50,000 or more g/mmol/hr. In an alternative embodiment, the conversion of olefin monomer is at least about 10%, based upon polymer yield (weight) and the weight of the monomer entering the reaction zone, such as about 20% or more, such as about 30% or more, such as about 50% or more, such as about 80% or more.

In at least one embodiment, little or no alumoxane is used in the process to produce the polymers. Alumoxane can be present at zero mol %, alternatively the alumoxane can be present at a molar ratio of aluminum to transition metal less than 500:1, such as less than 300:1, such as less than 100:1, such as less than 1:1.

In at least one embodiment, little or no scavenger is used in the process to produce the ethylene polymer. For example, scavenger (such as trialkyl aluminum) can be present at zero mol %, alternatively the scavenger can be present at a molar ratio of scavenger metal to transition metal of less than 100:1, such as less than 50:1, such as less than 15:1, such as less than 10:1.

In at least one embodiment, the polymerization: 1) is conducted at temperatures of 0° C. to 300° C., such as 25° C. to 150° C., 40° C. to 120° C., 45° C. to 80° C.; 2) is conducted at a pressure of atmospheric pressure to 10 MPa, such as from 0.35 MPa to 10 MPa, from 0.45 MPa to 6 MPa, or from 0.5 MPa to 4 MPa; 3) is conducted in an aliphatic hydrocarbon solvent (such as isobutane, butane, pentane, isopentane, hexanes, isohexane, heptane, octane, dodecane, and mixtures thereof; cyclic or alicyclic hydrocarbons, such as cyclohexane, cycloheptane, methylcyclohexane, methylcycloheptane, or mixtures thereof. In some embodiments, where aromatics are present in the solvent, the aromatics are present at about 1 wt % or less, such as about 0.5 wt % or less, or about 0 wt % based upon the weight of the solvents); 4) where the catalyst composition used in the polymerization includes less than 0.5 mol % alumoxane, such as about 0 mol % alumoxane. Alternatively, the alumoxane is present at a molar ratio of aluminum to transition metal of a catalyst of less than 500:1, such as less than 300:1, less than 100:1, less than 1:1; 5) the polymerization may occurs in one reaction zone; 6) the productivity of the catalyst is at least 80,000 g/mmol/hr (such as at least 150,000 g/mmol/hr, at least 200,000 g/mmol/hr, at least 250,000 g/mmol/hr, or at least 300,000 g/mmol/hr); and 7) optionally, scavengers (such as trialkyl aluminum compounds) are absent (e.g., present at zero mol %). Alternatively, the scavenger is present at a molar ratio of scavenger metal to transition metal of less than 100:1, such as less than 50:1, less than 15:1, or less than 10:1; and 8) optionally hydrogen is present in the polymerization reactor at a partial pressure of 0.001 to 50 psig (0.007 to 345 kPa) (such as from 0.01 to 25 psig (0.07 to 172 kPa), or from 0.1 to 10 psig (0.7 to 70 kPa)). In some embodiments, the catalyst composition used in the polymerization includes no more than one catalyst. A “reaction zone”, is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In some embodiments, the polymerization occurs in one reaction zone.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Chain transfer agents may be alkylalumoxanes, a compound represented by the formula AiR₃, ZnR₂ (where each R is, independently, a C1-C8 aliphatic radical, such as methyl, ethyl, propyl, butyl, pentyl, hexyl, heptyl, octyl or an isomer thereof) or a combination thereof, such as diethyl zinc, methylalumoxane, trimethylaluminum, triisobutylaluminum, trioctylaluminum, or a combination thereof.

### Polyolefin Products

The present disclosure also relates to polyolefin compositions, such as resins, produced by the catalyst compositions and polymerization processes of the present disclosure. Because the catalyst composition has reduced aromatic hydrocarbon content, polyolefins of the present disclosure also have reduced aromatic hydrocarbon content, for example a polyolefin produce can have about 1,000 ppb or less aromatic hydrocarbon content, such as about 500 ppb or less, about 300 ppb or less, or about 200 ppb or less aromatic hydrocarbon content.

In at least one embodiment, a process includes utilizing a catalyst composition of the present disclosure to produce propylene homopolymers or propylene copolymers, such as propylene-ethylene and/or propylene-alphaolefin (such as C3 to C20) copolymers (such as propylene-hexene copolymers or propylene-octene copolymers) having an Mw/Mn of about 1 or greater, such as about 2 or greater, about 3 or greater, or about 4 or greater.

In at least one embodiment, a process includes utilizing a catalyst composition of the present disclosure to produce olefin polymers, such as polyethylene and polypropylene homopolymers and copolymers. In at least one embodiment, the polymers produced are homopolymers of ethylene or copolymers of ethylene having from about 0 and 25 mol % of one or more C3 to C20 olefin comonomer (such as from about 0.5 and 20 mol %, such as from about 1 to about 15 mol %, such as from about 3 to about 10 mol %).

Polymers produced may have an Mw of from about 5,000 to about 1,000,000 g/mol (such as from about 25,000 to about 750,000 g/mol, such as from about 50,000 to about 500,000 g/mol), and/or an Mw/Mn of from about 1 to about 40 (such as from about 1.2 to about 20, such as from about 1.3 to about 10, such as from about 1.4 to about 5, such as from about 1.5 to about 4, such as from about 1.5 to about 3).

In at least one embodiment, the polymer produced has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versa).

Unless otherwise indicated, the distribution and the moments of molecular weight (Mw, Mn, Mz, Mw/Mn, etc.), the comonomer content and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2700 cm⁻¹ to about 3000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) including ˜300 ppm antioxidant BHT can be used as the mobile phase at a nominal flow rate of ˜1 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at −160° C. with continuous shaking. The sample solution concentration can be from ˜0.2 to ˜2 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass, which is equal to the pre-determined concentration multiplied by injection loop volume. The conventional molecular weight (IR MW) is determined by combining universal calibration relationship with the column calibration, which is performed with a series of monodispersed polystyrene (PS) standards ranging from 700 to 10M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, α and K for other materials are as calculated and published in literature (Sun, T. et al. Macromolecules 2001, 34, 6812), except that for purposes of the present disclosure and claims thereto, α=0.700 and K=0.0003931 for ethylene, propylene, diene monomer copolymers, OR {α=0.695+(0.01*(wt. fraction propylene)) and K=0.000579-(0.0003502*(wt. fraction propylene)) for ethylene-propylene copolymers and ethylene-propylene-diene terpolymers}, α=0.695 and K=0.000579 for linear ethylene polymers, α=0.705 and K=0.0002288 for linear propylene polymers, α=0.695 and K=0.000181 for linear butene polymers, a is 0.695 and K is 0.000579*(1-0.0087*w2b+0.000018*(w2b)\hat{ }2) for ethylene-butene copolymer where w2b is a bulk weight percent of butene comonomer, a is 0.695 and K is 0.000579*(1−0.0075*w2b) for ethylene-hexene copolymer where w2b is a bulk weight percent of hexene comonomer, and α is 0.695 and K is 0.000579*(1-0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which ƒ is 0.3, 0.4, 0.6, 0.8, and so on for C3, C4, C6, C8, and so on co-monomers, respectively:

w2=ƒ*SCB/1000TC

The bulk composition of the polymer from the GPC-IR and GPC-4D analyses is obtained by considering the entire signals of the CH₃ and CH₂ channels between the integration limits of the concentration chromatogram. First, the following ratio is obtained:

$$Bulk IR ratio = \frac{Area of {CH}_{3} signal within integration limits}{Area of {CH}_{2} signal within integration limits}$$

Subsequently, the same calibration of the CH₃ and CH₂ signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight averaging the chain-end correction over the molecular-weight range. Then

w2b=ƒ*bulk CH₃/1000TC

bulk SCB/1000TC=bulk CH₃/1000TC−bulk CH₃end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avh} = \frac{\sum {{c}_{i} [ η ]}_{i}}{\sum {c}_{i}}$$

where the summations are over the chromatographic slices, i, between the integration limits. The branching index g′ᵥᵢₛ is defined as:

$${g}_{vis}^{′} = \frac{{[ η ]}_{avg}}{{KM}_{v}^{α}}$$

where Mᵥ is the viscosity-average molecular weight based on molecular weights determined by LS analysis and K and α are for the reference linear polymer, which are, for purposes of this present disclosure and claims thereto, α=0.700 and K=0.0003931 for ethylene, propylene, diene monomer copolymers, OR[α=0.695+(0.01*(wt. fraction propylene)) and K=0.000579-(0.0003502*(wt. fraction propylene)) for ethylene-propylene copolymers and ethylene-propylene-diene terpolymers], α=0.695 and K=0.000579 for linear ethylene polymers, α=0.705 and K=0.0002288 for linear propylene polymers, α=0.695 and K=0.000181 for linear butene polymers, a is 0.695 and K is 0.000579*(1−0.0087*w2b+0.000018*(w2b)\hat{ }2) for ethylene-butene copolymer where w2b is a bulk weight percent of butene comonomer, a is 0.695 and K is 0.000579*(1-0.0075*w2b) for ethylene-hexene copolymer where w2b is a bulk weight percent of hexene comonomer, and α is 0.695 and K is 0.000579*(1-0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

The catalyst composition includes a support and therefore the polyolefin product may include aluminum or silica from the catalyst composition. The entrained aluminum and silica may provide improved physical and rheological properties. The polyolefin may have an aluminum content of about 1 ppm to about 10 ppm, such as about 1 ppm to about 7 ppm, or about 1 ppm to about 5 ppm. Additionally, the polyolefin may have a silica content of about 1 ppm or greater, such as about 10 ppm or greater, 25 ppm or greater, about 50 ppm or greater, or about 100 ppm or greater.

### Blends

In at least one embodiment, the polymer (such as polyethylene or polypropylene) produced is combined with one or more additional polymers prior to being formed into a film, molded part or other article. Blends of the present disclosure can have 0.01 mg/m² or less toluene. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, polyesters, polyacetal, polyvinylidine fluoride, polyethylene glycols, and/or polyisobutylene.

In at least one embodiment, the polymer (such as polyethylene or polypropylene) is present in the above blends, at from about 10 to about 99 wt %, based upon the weight of total polymers in the blend, such as from about 20 to about 95 wt %, such as from about 30 to about 90 wt %, such as from about 40 to about 90 wt %, such as from about 50 to about 90 wt %, such as from about 60 to about 90 wt %, such as from about 70 to about 90 wt %.

Blends of the present disclosure may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

Blends of the present disclosure may be formed using suitable equipment and methods, such as by dry blending the individual components, such as polymers, and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents, such as Optibloc® agents from Specialty Minerals Inc.; release agents; anti-static agents; pigments; colorants; dyes; waxes; silica; fillers; talc; mixtures thereof, and the like.

In at least one embodiment, a polyolefin composition, such as a resin, that is a multi-modal polyolefin composition includes a low molecular weight fraction and/or a high molecular weight fraction. In at least one embodiment, the high molecular weight fraction is produced by the catalyst represented by Formula (I). The low molecular weight fraction may be produced by a second catalyst that is a bridged or unbridged metallocene catalyst, as described above. The high molecular weight fraction may be polypropylene, polyethylene, and copolymers thereof. The low molecular weight fraction may be polypropylene, polyethylene, and copolymers thereof.

In at least one embodiment, the polyolefin composition produced by a catalyst composition of the present disclosure has a comonomer content from about 3 wt % to about 15 wt %, such as from about 4 wt % and bout 10 wt %, such as from about 5 wt % to about 8 wt %. In at least one embodiment, the polyolefin composition produced by a catalyst composition of the present disclosure has a polydispersity index of from about 2 to about 6, such as from about 2 to about 5.

### Films

The foregoing polymers, such as the foregoing polyethylenes or blends thereof, may be used in a variety of end-use applications. In some embodiments, polymers used in the production of films are blended with recycled polymers to produce polyethylene blends. Films of the present disclosure can have 0.01 mg/m² or less toluene. Such applications include, for example, mono- or multi-layer blown, extruded, and/or shrink films. These films may be formed by extrusion or coextrusion techniques, such as a blown bubble film processing technique, where the composition can be extruded in a molten state through an annular die and then expanded to form a uni-axial or biaxial orientation melt prior to being cooled to form a tubular, blown film, which can then be axially slit and unfolded to form a flat film.

Films may be unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble process and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically, the films are oriented in the Machine Direction (MD) at a ratio of up to 15, such as from 5 to 7, and in the Transverse Direction (TD) at a ratio of up to 15, such as 7 to 9. However, in another embodiment, the film is oriented to the same extent in both the MD and TD directions.

The films may vary in thickness depending on the intended application; however, films of a thickness from 1 μm to 50 μm may be suitable. Films intended for packaging are usually from 10 μm to 50 μm thick. The thickness of the sealing layer is typically 0.2 μm to 50 μm. There may be a sealing layer on both the inner and outer surfaces of the film or the sealing layer may be present on only the inner or the outer surface.

The catalyst compositions having reduced aromatic hydrocarbon content produce a polyolefin with reduced aromatic hydrocarbon, and, therefore, the films produced from the polyolefins may have a reduced aromatic hydrocarbon content, such as a reduced toluene content. For example, polyolefin films of the present disclosure may have about 0.1 mg/m² or less aromatic hydrocarbon, such as about 0.05 mg/m² or less, about 0.01 mg/m² or less, about 0.005 mg/m² or less, or about 0.001 mg/m² or less aromatic hydrocarbon. Additionally, polyolefin films of the present disclosure may have about 0.1 mg/m² or less toluene, such as about 0.05 mg/m² or less, 0.01 mg/m² or less, about 0.01 mg/m² or less, about 0.005 mg/m² or less, or about 0.001 mg/m² or less toluene.

Furthermore, the catalyst composition is supported and therefore the polyolefin films may include aluminum or silica from an inorganic oxide support. The polyolefin films of the present disclosure may have about 0.001 wt % or greater aluminum, such as about 0.005 wt % or greater, about 0.01 wt % or greater, about 0.05 wt % or greater, or about 0.1 wt % or greater aluminum. Additionally, the polyolefin films of the present disclosure may have about 0.001 wt % or greater silica, such as about 0.005 wt % or greater, about 0.01 wt % or greater, about 0.05 wt % or greater, about 0.1 wt % or greater, about 0.5 wt % or greater, or about 1 wt % or greater silica. In embodiments where the film includes antiblock additives, the polyolefin film may have about 0.5 wt % or greater silica content, such as about 1 wt % or greater, about 1.5 wt % or greater, or about 2 wt % or greater.

In some embodiments, one or more layers may be modified by corona treatment, electron beam irradiation, gamma irradiation, flame treatment, or microwave. In at least one embodiment, one or both of the surface layers is modified by corona treatment.

### Embodiments of the Present Disclosure

Clause 1. A process for producing a catalyst composition consisting of:
mixing a catalyst compound having a transition metal atom, an activator, and a support to form a supported catalyst mixture; and
drying the supported catalyst mixture at a pressure of about 10 kPa or less and a temperature of about 60° C. or greater for a period of about 6 h or less.

Clause 2. A process for producing a catalyst composition including:
mixing a catalyst compound having a transition metal atom and a support to form a supported catalyst mixture; and
drying the supported catalyst mixture at a pressure of about 10 kPa or less and a temperature of about 60° C. or greater for a period of about 6 hours or less, where aliphatic hydrocarbon is not introduced to the supported catalyst mixture after drying.

Clause 3. The process of Clause 2, where the mixing further includes mixing an activator with the catalyst compound and the support to form the supported catalyst mixture.

Clause 4. A catalyst composition formed by the process of any of Clauses 1 to 3.

Clause 5. A catalyst composition including:
a catalyst compound having a transition metal atom;
an aluminum activator; and
a support,
where the catalyst composition includes about 0.5 wt % to about 1.5 wt % aromatic hydrocarbon; and
where the catalyst composition includes less than 1 wt % of aliphatic hydrocarbon.

Clause 6. A process for producing polyolefins, the process including:
introducing a catalyst composition and at least one olefin to a polymerization reactor,
where the catalyst composition includes:
   a catalyst compound having a transition metal atom,
   an aluminum activator, and
   a support;
where the catalyst composition includes:
   about 0.5 wt % to about 1.5 wt % aromatic hydrocarbon content, and
   less than 1 wt % of aliphatic hydrocarbon content; and obtaining a polyolefin having about 300 ppb or less aromatic hydrocarbon.

Clause 7. The process of Clause 6, where the catalyst composition includes about 1.2 wt % or less toluene.

Clause 8. The process of Clause 6, where the catalyst composition includes about 1.2 wt % or less aromatic hydrocarbon content.

Clause 9. The process of any of Clauses 6 to 8, where the catalyst composition includes about 0.8 wt % to about 1.2 wt % aromatic hydrocarbon content.

Clause 10. The process of any of Clauses 6 to 9, where the polyolefin has an aluminum content of about 1 ppm to about 5 ppm.

Clause 11. The process of any of Clauses 6 to 10, where the polyolefin has a silica content of about 50 ppm or greater.

Clause 12. The process of any of Clauses 6 to 11, further including extruding the polyolefin to form a polyolefin film.

Clause 13. The process of Clause 12, where the polyolefin film has a toluene concentration of about 0.05 mg/m² or less.

Clause 14. The process of any of Clauses 12 to 13, where the polyolefin film has a weight percent of aluminum of about 0.01 wt % or greater.

Clause 15. The process of any of Clauses 6 to 14, where the catalyst compound is selected from the group consisting of:
bis(1-methyl, 3-n-butyl cyclopentadienyl) zirconium dichloride;
dimethylsilyl bis(tetrahydroindenyl) zirconium dichloride;
bis(n-propylcyclopentadienyl) hafnium dimethyl;
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H)₂C(tetramethylcyclopentadienyl)(1-cyclododecylamido)M(R)₂; and
μ-(CH₃)₂Si(η⁵-2,6,6-trimethyl-1,5,6,7-tetrahydro-s-indacen-1-yl)(tertbutylamido)M(R)₂;
   where M is selected from Ti, Zr, and Hf; and R is selected from halogen or C1 to C5 alkyl.

Clause 16. The process of Clause 15, where the activator is selected from the group consisting of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetra(perfluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-diethylanilinium tetrakis(perfluoronaphthyl)borate, N,N-dimethyl-(2,4,6-trimethylanilinium) tetrakis(perfluoronaphthyl)borate, and tropillium tetrakis(perfluoronaphthyl)borate.

Clause 17. The process of Clause 16, where the support is selected from the group consisting of Al₂O₃, ZrO₂, SiO₂, SiO₂/Al₂O₂, silica clay, or mixture(s) thereof.

Clause 18. A process for producing polyolefins, the process including:
introducing a catalyst composition and ethylene to a gas phase polymerization reactor,
where the catalyst composition includes:
   a catalyst compound having a transition metal atom,
   an aluminum activator, and
   a support;
where the catalyst composition includes:
   about 0.5 wt % to about 1.5 wt % aromatic hydrocarbon content, and
   less than 1 wt % of aliphatic hydrocarbon content; and
obtaining a polyolefin having about 300 ppb or less aromatic hydrocarbon.

Clause 19. The process of Clause 18, where the catalyst composition includes about 1.5 wt % or less toluene.

Clause 20. The process of any of Clauses 18 to 19, where the catalyst composition includes about 1.2 wt % or less aromatic hydrocarbon content.

Clause 21. The process of any of Clauses 18 to 20, where the polyolefin has an aluminum content of about 5 ppm or less.

Clause 22. The process of any of Clauses 18 to 21, where the polyolefin has a silica content of about 200 ppm or less.

Clause 23. A process for producing polyolefins, the process including:
introducing a catalyst composition and ethylene to a gas phase polymerization reactor,
where the catalyst composition includes:
   a metallocene catalyst compound having a transition metal atom selected from
   hafnium, zirconium, or titanium,
   an aluminum activator, and
   a support;
where the catalyst composition includes:
   about 0.5 wt % to about 1.5 wt % aromatic hydrocarbon content, and
   less than 1 wt % of aliphatic hydrocarbon content; and
obtaining a polyolefin having about 300 ppb or less aromatic hydrocarbon.

Clause 24. The process of Clause 23, where the catalyst composition includes about 1.2 wt % or less toluene.

Clause 25. The process of Clause 24, where the catalyst composition includes about 1.2 wt % or less aromatic hydrocarbon content.

Clause 26. A polyethylene resin having:
a toluene content of about 300 ppb or less;
an aluminum content of about 5 ppm or greater;
a silica content of about 50 ppm or greater.

Clause 27. The polyethylene of Clause 26, the polyethylene having:
a Mw of about 15,000 g/mol to about 2,000,000 g/mol;
a Mn of about 2,500 g/mol to about 2,500.00 g/mol;
a MI of about 0.2 g/10 min to about 1.5 g/10 min (190° C./2.16 kg);
a PDI of about 1 to about 3;
a g′ᵥᵢₛ of about 0.85 or greater; and a density of about 0.91 to about 0.93.

Clause 28. A polyethylene film having:
a toluene concentration of about 0.05 mg/m² or less;
a weight percent of aluminum of about 0.01 or greater.

### Examples

### General

All reagents were obtained from Sigma Aldrich (St. Louis, Mo.) and used as obtained, unless stated otherwise. All solvents were anhydrous. All reactions were performed under an inert nitrogen atmosphere, unless otherwise stated. All deuterated solvents were obtained from Cambridge Isotopes (Cambridge, Mass.) and dried over 3 Angstrom molecular sieves before use.

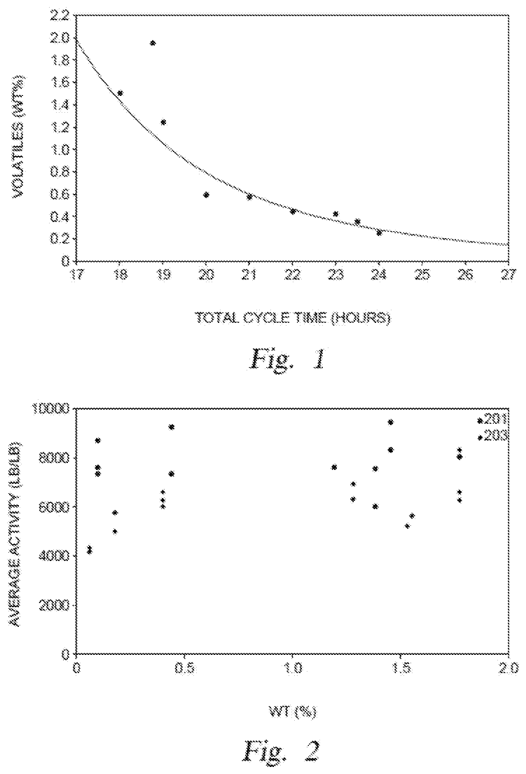

FIG. 1 shows percent volatiles in a drying curve for a catalyst composition according to one embodiment. About 20 hours of drying time was used in order to bring volatiles under 1 wt %. The curve was fit to the data using algorithmic regression providing an equation relating volatiles wt % to drying time in hours of:

Volatiles wt %=2*10⁷*(drying time)^{-5.641}

The R² value for the equation is 0.9389.

FIG. 2 is a graph showing average catalyst activity in pounds of polymer produced per pound of catalyst against weight percent volatiles. A catalyst was used to produce two different grades of ethylene:hexene copolymer. The ethylene:hexene copolymer represented by circles 201 is a low density polyethylene copolymer with a density from about 0.912 g/cm³ to about 0.92 g/cm³. The ethylene:hexene copolymer represented by diamonds 203 is a higher density polyethylene copolymer with a density from about 0.92 g/cm³ to about 0.94 g/cm³. Drying the catalyst to a low wt % of volatiles had no statistical impact on catalyst continuity or activity determined from either catalyst feed rate or residual zirconium.

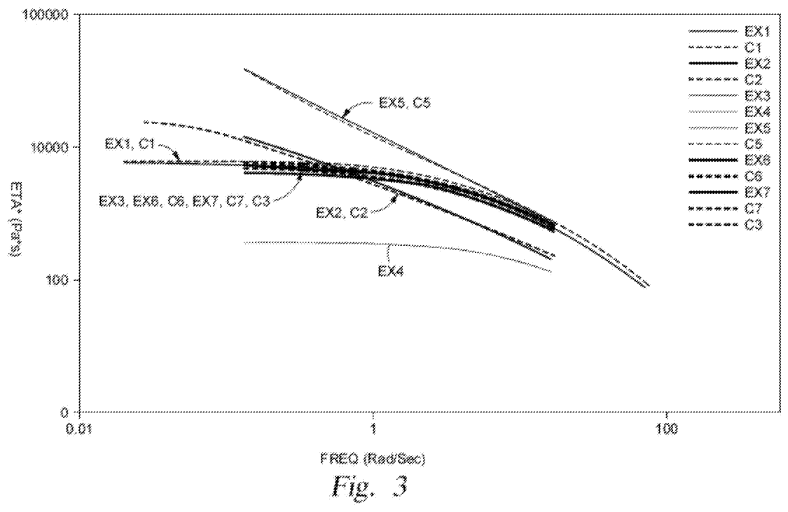

In order to compare polyethylene properties made from catalysts with reduced aromatic hydrocarbon content compared to previous catalysts, polyethylenes were produced and properties tested. The polyethylenes produced were ethylene:hexene copolymers with varying densities and melt indices. FIGS. 3-8 compare properties of polyethylenes made with metallocene catalyst compositions with reduced aromatic hydrocarbon and comparative catalyst compositions where the aromatic hydrocarbon was not reduced. Table 1 is a details the polyethylenes shown in FIGS. 3 through 8.

TABLE 1
Polyethylenes Examples and Comparatives (FIGS. 3-8)

| | Aromatic Hydrocarbon | Density | Melt Index 2.16 |
|---|---|---|---|
| Example | wt % | (g/cm³) | kg (g/10 min) |
| Ex 1 | 0.1 | 0.918 | 1.0 |
| C1 | 1.19 | 0.918 | 1.0 |
| Ex 2 | 0.06 | 0.920 | 1.0 |
| C2 | 1.28 | 0.920 | 1.0 |
| Ex 3 | 0.1 | 0.912 | 1.0 |
| C3 | 1.38 | 0.912 | 1.0 |
| Ex 4 | 0.1 | 0.912 | 3.8 |
| Ex 5 | 0.4 | 0.916 | 0.2 |
| C5 | 1.77 | 0.916 | 0.2 |
| Ex 6 | 0.44 | 0.912 | 1.0 |
| C6 | 1.45 | 0.912 | 1.0 |
| Ex 7 | 0.44 | 0.912 | 1.0 |
| C7 | 1.45 | 0.912 | 1.0 |

FIG. 3 is a graph comparing complex shear viscosity in pascal seconds versus frequency in radians per second of polyethylene examples according to some embodiments, and comparatives of polyethylenes made using catalysts with higher wt % volatiles. The complex sheer viscosity of the polyethylenes made using catalyst with reduced aromatic hydrocarbon content is very similar to the corresponding comparative examples using catalysts without reduction of aromatic hydrocarbon content. Measurements were taken using 25 mm cast plates at 190° C. under 5-10% strain.

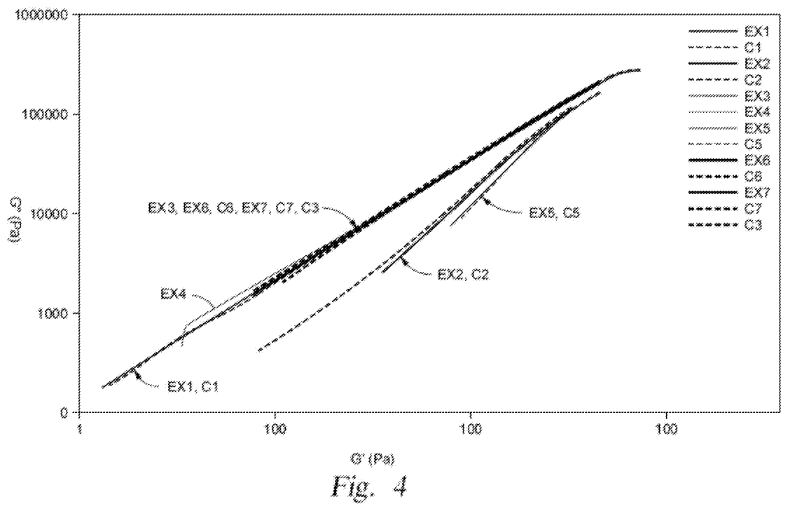

FIG. 4 is a graph comparing viscous modulus in pascals versus elastic modulus in pascals of polyethylene examples according to some embodiments, and comparatives of polyethylenes made using catalysts with higher wt % volatiles. The comparison of viscous modulus and elastic modulus of the polyethylenes made using catalyst with reduced aromatic hydrocarbon content is very similar to the corresponding comparative examples using catalysts without reduction of aromatic hydrocarbon content. Measurements were taken using 25 mm cast plates at 190° C. under 5-10% strain.

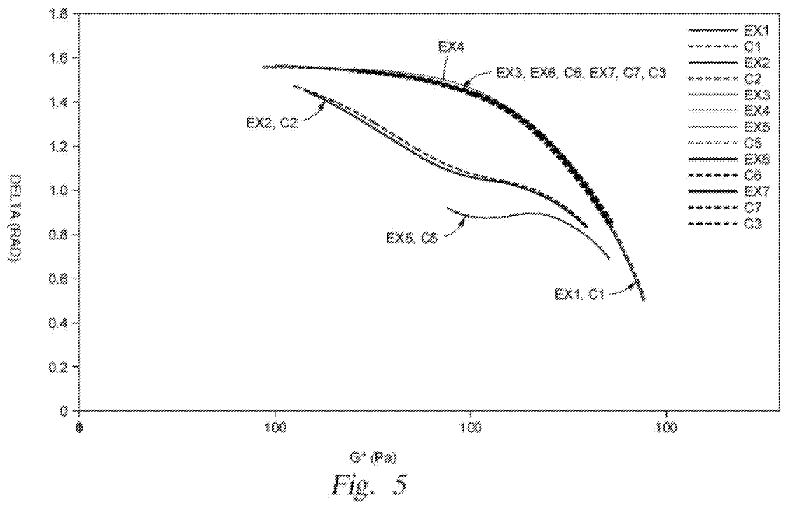

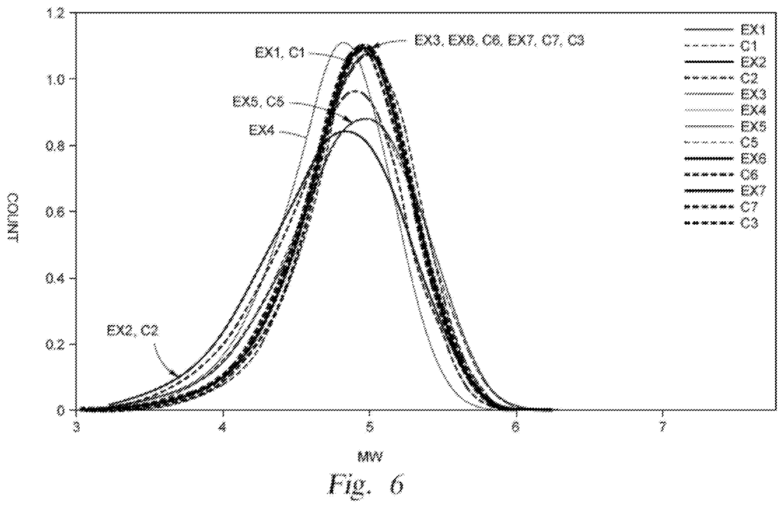

FIG. 5 is a van Gurp-Palmen Plot comparing phase angles in radians versus absolute values of the complex shear modulus in pascals of polyethylene examples according to some embodiments, and comparatives of polyethylenes made using catalysts with higher wt % volatiles. The van Gurp-Palmen Plot of the polyethylenes made using catalyst compositions with reduced aromatic hydrocarbon content is very similar to the corresponding comparative examples using catalyst compositions without reduction of aromatic hydrocarbon content. Measurements were taken using 25 mm cast plates at 190° C. under 5-10% strain.

FIG. 6 is a Four Dimensional Gel-Permeation Chromatograph showing counts versus molecular weight of polyethylene examples according to some embodiments, and comparatives of polyethylenes made using catalysts with higher wt % volatiles. The GPC-4D of the polyethylenes made using catalyst with reduced aromatic hydrocarbon content is very similar to the corresponding comparative examples using catalysts without reduction of aromatic hydrocarbon content.

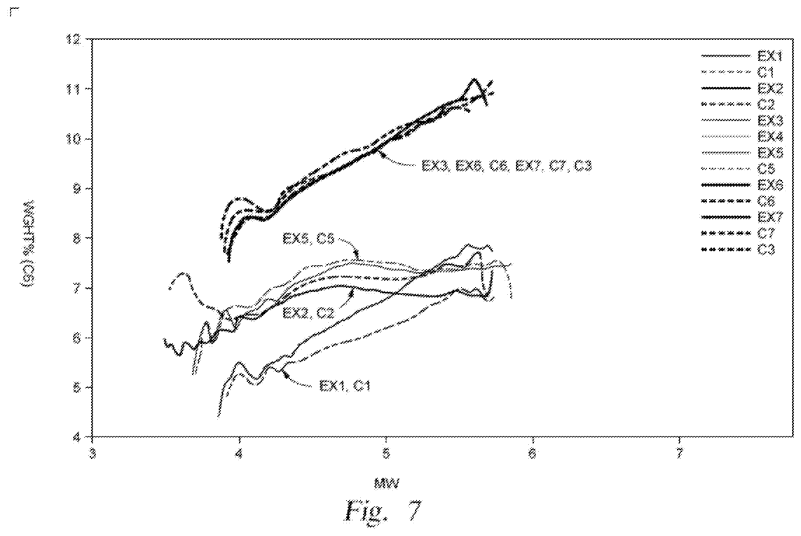

FIG. 7 is a Four Dimensional Gel-Permeation Chromatograph showing 1-hexene incorporation in weight percent versus molecular weight of polyethylene examples according to some embodiments, and comparatives of polyethylenes made using catalysts with higher wt % volatiles. The GPC-4D of the polyethylenes made using catalyst with reduced aromatic hydrocarbon content shows very similar comonomer incorporation as compared to the corresponding comparative examples using catalysts without reduction of aromatic hydrocarbon content.

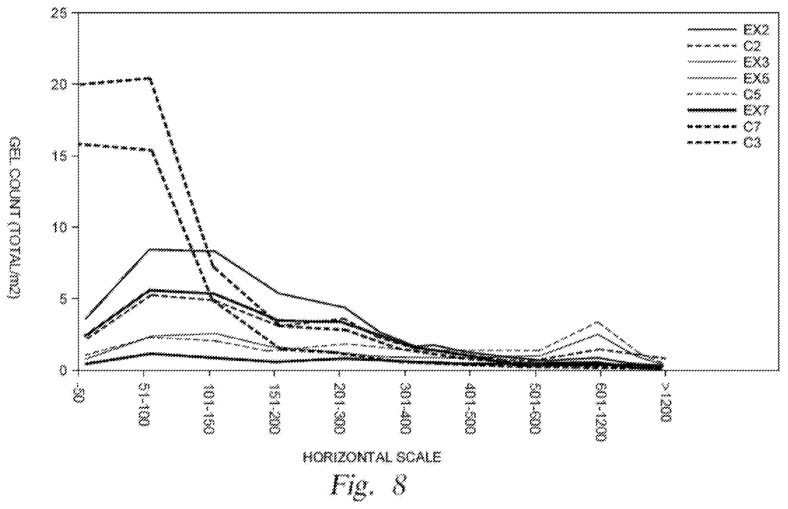

FIG. 8 is a graph of a gel count per meter squared versus frequency of finding gels in polyethylene examples according to some embodiments, and comparatives of polyethylenes made using catalysts with higher wt % volatiles. The gel count of the polyethylenes made using catalyst with reduced aromatic hydrocarbon content is very similar to the corresponding comparative examples using catalysts without reduction of aromatic hydrocarbon content.

Various catalysts were dried to low wt % volatile sand used to produce polyethylenes. Similarly, the same catalysts were not subjected to the same drying procedures and run as comparatives. The activity data is summarized in Table 2. The weight percent of aluminum and zirconium in the catalyst was determined by molecular ICP performed on the catalyst. The concentration of aluminum and zirconium in the polyethylene was determined by ICP performed on the PE.

TABLE 2
Activity Summary for Supported Metallocene Catalysts

| | Volatiles | Catalyst | Catalyst | Produced | Produced | Zr | Al | Total |
|---|---|---|---|---|---|---|---|---|
| Example | wt % | Al wt % | Zr wt % | PE Al ppm | PE Zr ppm | Activity | Activity | Activity |
| Ex 8 | 0.06 | 11.56 | 0.3 | 27.46 | 0.74 | 4054 | 4210 | 4227 |
| C8 | 1.28 | 11.6 | 0.31 | 16.77 | 0.41 | 7561 | 6917 | 6283 |
| Ex 9 | 0.1 | 12.02 | 0.39 | 15.87 | 0.51 | 7647 | 7574 | 7327 |
| C9 | 1.38 | 11.7 | 0.38 | 162.68 | 0.39 | 9744 | 719 | 7524 |
| Ex 10 | 0.4 | 11.63 | 0.31 | 19.16 | 0.52 | 5962 | 6070 | 6565 |
| C10 | 1.77 | 11.55 | 0.29 | 19.42 | 0.54 | 5370 | 5947 | 8290 |
| Ex 11 | 0.4 | 11.63 | 0.31 | 20.07 | 0.54 | 5741 | 5795 | 6564 |
| C11 | 1.77 | 11.55 | 0.29 | 21.06 | 0.58 | 5000 | 5484 | 8289 |
| Ex 12 | 0.4 | 11.63 | 0.31 | 18.95 | 0.51 | 6078 | 6137 | 6565 |
| C12 | 1.77 | 11.55 | 0.29 | 18.98 | 0.53 | 5472 | 6085 | 8290 |
| Ex 13 | 0.44 | 11.52 | 0.44 | 12.00 | 0.41 | 10732 | 9600 | 7321 |
| C13 | 1.45 | 11.47 | 0.4 | 185.00 | 0.38 | 10526 | | 8276 |

Some of the polyethylenes produced were processed into films using a blown film process.

The films produced from the polyethylenes made from catalyst compositions with reduced aromatics had similar properties, but contained less toluene than the films made from the polyethylenes produced with catalysts without reduction of aromatic hydrocarbon content. Film properties were measured according to the following ASTM or PFLF standards: Gauge (ASTM D6988); Tensile (including yield and elongation) (PLFL 242.001); Tear (ASTMD1922); Haze (ASTM D1003); Internal Haze (PLFL 244.001); Dart Drop (ASTM D1709—Phenolic, Method (g)); and Puncture (PFLF201.01—Method B1). The toluene content and film properties are shown in Table 3.

TABLE 3
Film Process Data and Properties

| Example | Ex 3 | C3 | Ex 5 | C5 | Ex 7 | C7 | Ex 8 | C8 |
|---|---|---|---|---|---|---|---|---|
| Volatiles wt % | 0.1 | 1.38 | 0.4 | 1.77 | 0.44 | 1.45 | 0.06 | 1.28 |
| Additive | HA | MK | ML | ML | HA | MK | HA | HA |
| Motor Load (psi) | 55.5 | | 61.3 | 61.9 | 51.4 | 63.5 | 51.9 | 52.5 |
| Press (%) | 7230.9 | | 8241.1 | 8303.5 | 6667.0 | 7917.1 | 5224.8 | 5392.2 |
| Melt Temp (° C.) | 236.2 | | 229.6 | 229.9 | 235.1 | 216.9 | 202.6 | 203.3 |
| Spin Rate (lb/h/RPM) | 5.69 | | 6.48 | 6.44 | 5.36 | 8.52 | 7.31 | 7.44 |
| Average Gage (mil) | 0.99 | 0.99 | 1.00 | 0.99 | 0.98 | 0.99 | 1.00 | 0.99 |
| Low Gage (mil) | 0.92 | 0.87 | 0.89 | 0.90 | 0.84 | 0.87 | 0.93 | 0.91 |
| High Gage (mil) | 1.10 | 1.07 | 1.12 | 1.09 | 1.07 | 1.08 | 1.06 | 1.14 |
| MD Yield Strength (psi) | 989 | 947 | 1,284 | 1,308 | 1,007 | 973 | 1,462 | 1,390 |
| TD Yield Strength (psi) | 971 | 926 | 1,470 | 1,415 | 983 | 976 | 1,503 | 1,481 |
| MD Elongation at | 7.4 | 7.5 | 6.4 | 6.6 | 7.5 | 7.5 | 7.0 | 6.2 |
| yield (%) | | | | | | | | |
| TD Elongation at | 6.9 | 7.0 | 7.8 | 6.0 | 6.9 | 7.5 | 6.2 | 6.1 |
| yield (%) | | | | | | | | |
| MD Tensile | 8,716 | 7,793 | 8,063 | 7,350 | 9,228 | 8,469 | 6,920 | 7,415 |
| Strength (psi) | | | | | | | | |
| TD Tensile | 8,336 | 5,870 | 9,150 | 9,167 | 8,589 | 5,396 | 6,803 | 6,854 |
| Strength (psi) | | | | | | | | |
| MD Elongation at | 455 | 427 | 365 | 335 | 474 | 429 | 446 | 479 |
| Break (%) | | | | | | | | |
| TD Elongation at | 614 | 561 | 663 | 663 | 627 | 554 | 701 | 719 |
| Break (%) | | | | | | | | |
| MD Elmendorf Tear | 174 | 157 | 46 | 54 | 176 | 172 | 113 | 109 |
| TD Elmendorf Tear | 315 | 322 | 369 | 396 | 337 | 338 | 573 | 535 |
| Haze (%) | 12.7 | 11.4 | 10.7 | 10.8 | 5.4 | 9.7 | 8.8 | 7.9 |
| Internal Haze (%) | 1.1 | 1.3 | 1.3 | 1.2 | 1.1 | 1.4 | 1.6 | 1.8 |
| Dart Drop Impact | 659 | 518 | 398 | 470 | 668 | 500 | 178 | 167 |
| Strength (psi) | | | | | | | | |
| Puncture Resistance | 13.38 | 8.55 | 14.25 | 13.50 | 14.28 | 8.92 | 11.98 | 11.30 |
| Peak Force (lbs) | | | | | | | | |
| Puncture Resistance | 13.51 | 8.64 | 14.25 | 13.63 | 14.58 | 9.01 | 11.98 | 11.41 |
| Peak Force (lbs/mil) | | | | | | | | |
| Puncture Resistance | 44.96 | 20.44 | 40.40 | 36.25 | 53.37 | 21.91 | 33.99 | 29.16 |
| Break Energy (inch- | | | | | | | | |
| lbs) | | | | | | | | |
| Puncture Resistance | 45.42 | 20.65 | 40.40 | 36.61 | 54.45 | 22.13 | 33.99 | 29.45 |
| Break Energy (inch- | | | | | | | | |
| lbs/mil) | | | | | | | | |

Some differences in processability may be due to the additive package used in production of the films. The ML additive includes Irganox1076 in 500 ppm, Irganox 168 in 1000 ppm, Tris(nonylphenyl) phosphite (TNPP) in 0 ppm, Dynamar FX5929M, Talc in 0 ppm, erucamide in 0 ppm. The MK additive includes Irganox1076] in 500 ppm, Irganox 168 in 1000 ppm, Tris(nonylphenyl) phosphite (TNPP) in 0 ppm, Dynamar FX5929, Talc in 5000 ppm, erucamide in 1000 ppm. The HA additive includes Irganox 1076 in 300 ppm, Irganox 168 in 0 ppm, Tris(nonylphenyl) phosphite (TNPP in 1500 ppm, Dynamar FX5929, Talc in 0 ppm, erucamide in 0 ppm.

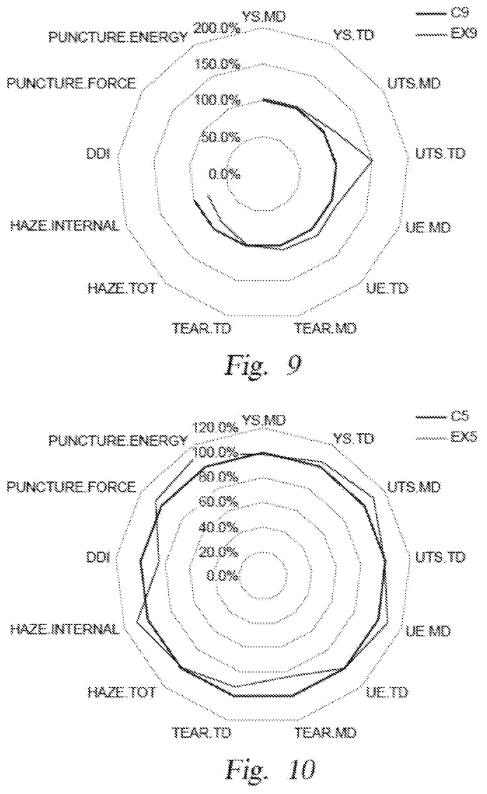

Although the additive package may cause differences in the processability of the examples and comparative examples, many of the properties may still be compared showing substantial similarity. Some of the examples and comparatives were processed with the same additive package and their film properties (including processability) may be directly compared. A few of these direct comparisons are shown in FIGS. 9-11.

FIG. 9 is a radar plot comparing an example polyethylene according to one embodiment with a polyethylene made using a catalyst containing higher wt % volatiles. The comparative polyethylene film is set at 100% in the radar plot and the example polyethylene is plotted as deviation from the comparative (in percent). The radar plot includes measurements in the machine direction (MD) and in the transverse direction (TD) of yield strength (YS.MD and YS.TD), ultimate tensile strength (UTS.MD and UTS.TD), Ultimate Elongation (UE.MD and UE.TD), Elmendorf tear strength (TEAR.MD and TEAR.TD). The radar plot also includes internal and total haze (HAZE.TOT), puncture force, puncture energy, and dart drop impact (DDI) strength. The plot shows that the polyethylene films have very similar properties, although one has reduced aromatic hydrocarbon from the catalyst composition used.

FIG. 10 is a radar plot comparing an example polyethylene (Ex 5) according to one embodiment with a polyethylene (C5) made using a catalyst containing higher wt % volatiles. The comparative polyethylene film is set at 100% in the radar chart and the example polyethylene is plotted as deviation from the comparative (in percent). The radar plot includes measurements in the machine direction (MD) and in the transverse direction (TD) of yield strength (YS.MD and YS.TD), ultimate tensile strength (UTS.MD and UTS.TD), Ultimate Elongation (UE.MD and UE.TD), Elmendorf tear strength (TEAR.MD and TEAR.TD). The radar plot also includes internal and total haze (HAZE.TOT), puncture force, puncture energy, and dart drop impact (DDI) strength. The plot shows that the polyethylene films have very similar properties, although one has reduced aromatic hydrocarbon from the catalyst used.

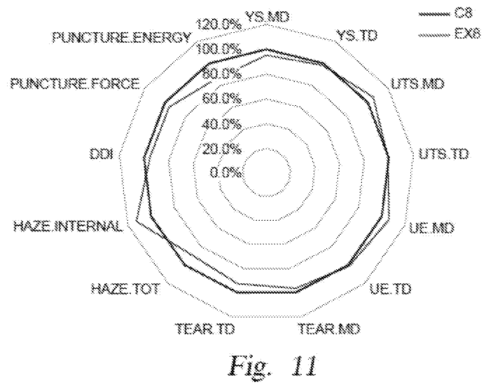

FIG. 11 is a radar plot comparing an example polyethylene (Ex 8) according to one embodiment with a polyethylene (C8) made using a catalyst containing higher wt % volatiles. The comparative polyethylene film is set at 100% in the radar plot and the example polyethylene is charted as deviation from the comparative (in percent). The radar plot includes measurements in the machine direction (MD) and in the transverse direction (TD) of yield strength (YS.MD and YS.TD), ultimate tensile strength (UTS.MD and UTS.TD), Ultimate Elongation (UE.MD and UE.TD), Elmendorf tear strength (TEAR.MD and TEAR.TD). The radar plot also includes internal and total haze (HAZE.TOT), puncture force, puncture energy, and dart drop impact (DDI) strength.

Additionally, the catalyst compositions with reduced aromatic hydrocarbon content operate similarly within gas phase reactors as compared to previous catalyst compositions without reduction of aromatic hydrocarbon. For example, the feed efficiency and gas feeds are equivalent to previous processes, see Table 4 for comparative examples.

TABLE 4
Reactor Operations Comparative and Example Catalyst Compositions

| Example | C14/15/16 | Ex 14 | Ex 15 | Ex 16 | C17 | Ex 17 | C11 | Ex 11 |
|---|---|---|---|---|---|---|---|---|
| Volatiles wt % | 1.28 | 0.06 | 0.06 | 0.06 | 1.53 | 0.18 | 1.77 | 0.40 |
| Melt Index | 1.09 | 1.04 | 1.00 | 0.97 | 0.43 | 0.45 | 0.17 | 0.17 |
| (g/10 min) | | | | | | | | |
| Density (g/cm³) | 0.9196 | 0.9205 | 0.9200 | 0.9194 | 0.9348 | 0.9347 | 0.9157 | 0.9157 |
| Ethylene Partial | 191.17 | 189.99 | 190.02 | 190.08 | 198.26 | 198.66 | 190.12 | 190.00 |
| Pressure | | | | | | | | |
| Hexene:Ethylene | 15.42 | 14.55 | 14.41 | 14.36 | 10.44 | 11.39 | 11.65 | 11.64 |
| ratio (ppm/mol) | | | | | | | | |
| Hexene:Ethylene | 0.0106 | 0.0113 | 0.0115 | 0.0115 | 0.0040 | 0.0038 | 0.0102 | 0.0103 |
| molar ratio | | | | | | | | |
| Reactor Bed | 163906 | 158919 | 157224 | 158844 | 159013 | 157865 | 159176 | 158714 |
| Weight (lbs) | | | | | | | | |
| Fluidized Bulk | 21.17 | 20.27 | 20.02 | 20.10 | 21.56 | 21.17 | 21.22 | 20.92 |
| Density (lbs/ft³) | | | | | | | | |
| Production Rate | 85757 | 115178 | 114729 | 114158 | 104345 | 112427 | 106214 | 104697 |
| (lbs/h) | | | | | | | | |
| Catalyst Productivity | 6283 | 4241 | 4227 | 4308 | 5208 | 4997 | 8290 | 6565 |
| (lbs/lb cat) | | | | | | | | |
| Residence Time | 1.94 | 1.39 | 1.39 | 1.41 | 1.53 | 1.40 | 1.51 | 1.52 |
| (Reactor Bed | | | | | | | | |
| Weight/Production Rate) | | | | | | | | |
| Isopentane | 15.74 | 15.70 | 15.71 | 15.71 | 17.60 | 17.96 | 15.25 | 15.61 |
| (mol %) | | | | | | | | |
| Isohexane | 0.1970 | 0.3929 | 0.4209 | 0.4511 | 0.2567 | 0.3055 | 0.5242 | 0.5645 |
| (mol %) | | | | | | | | |
| Condensing | 0.1778 | 0.2471 | 0.2449 | 0.2406 | 0.2008 | 0.2139 | 0.2084 | 0.2053 |
| agent (wt %) | | | | | | | | |

| Example | Ex 18 | Ex 19 | C18.1 | C19 | C18.2 | Ex 1 | Cl |
|---|---|---|---|---|---|---|---|
| Polymer Volatiles wt % | 0.1 | 0.44 | 1.38 | 1.45 | 1.77 | 0.1 | 1.19 |
| (catalyst toluene wt %) | | | | | | | |
| Polymer Melt Index | 0.99 | 0.99 | 1.60 | 1.04 | 0.99 | 1.05 | 1.45 |
| (g/10 min) | | | | | | | |
| Polymer Density | 0.9106 | 0.9108 | 0.9105 | 0.9097 | 0.9100 | 0.9185 | 0.9171 |
| (g/cm³) | | | | | | | |
| Ethylene Partial | 184.83 | 184.55 | 181.83 | 184.42 | 185.07 | 205.36 | 205.34 |
| Pressure (psi) | | | | | | | |
| Hexene:Ethylene | 3.18 | 3.22 | 3.02 | 3.31 | 3.26 | 2.52 | 2.72 |
| ratio (ppm/mol) | | | | | | | |
| Hexene:Ethylene | 0.0268 | 0.0280 | 0.0262 | 0.0271 | 0.0273 | 0.0199 | 0.0210 |
| molar ratio | | | | | | | |
| Reactor Bed | 173203 | 173908 | 171658 | 170268 | 168792 | 173897 | 166671 |
| Weight (lbs) | | | | | | | |
| Fluidized Bulk | 23.05 | 22.23 | 22.80 | 21.73 | 22.21 | 23.83 | 22.43 |
| Density (lbs/ft³) | | | | | | | |
| Production Rate | 104703 | 91717 | 87682 | 75237 | 105278 | 70573 | 113857 |
| (lbs/h) | | | | | | | |
| Catalyst Productivity | 7328 | 7321 | 7525 | 8276 | 8027 | 8664 | 7582 |
| (lbs/lb cat) | | | | | | | |
| Residence Time | 1.66 | 1.90 | 1.97 | 2.27 | 1.61 | 2.49 | 1.46 |
| (Reactor Bed | | | | | | | |
| Weight/Production Rate) | | | | | | | |
| Isopentane | 11.90 | 11.96 | 9.73 | 11.60 | 11.90 | 12.18 | 16.16 |
| (mol %) | | | | | | | |
| Isohexane | 0.6820 | 0.6500 | 0.6725 | 0.5064 | 0.6528 | 0.6216 | 0.6088 |
| (mol %) | | | | | | | |
| Condensing agent | 19 | 18 | 14 | 14 | 19 | 12 | 23 |
| (wt %) | | | | | | | |

Overall, it has been discovered that a catalyst composition may be produced with reduced aromatic hydrocarbon content (and reduced overall hydrocarbon content) and polyolefins produced using that catalyst have similar properties to polyolefins produced using previous catalyst compositions without reduction of aromatic hydrocarbon. Additionally, the catalyst compositions with reduced aromatic hydrocarbon content show similar activity to previous catalyst compositions without reduction of aromatic hydrocarbon. The combination of similar activity and production of polyolefins with similar properties means that the new catalyst compositions may be used without a loss of process continuity and the polyolefins produced with reduced aromatic hydrocarbon content may be used as direct replacement (of conventional polyolefins having higher aromatic hydrocarbon content) without forcing consumers to change their processing or usage.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of this disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of this disclosure have been illustrated and described, various modifications can be made without departing from the spirit and scope of this disclosure. Accordingly, it is not intended that this disclosure be limited thereby. Likewise whenever a composition, an element or a group of elements is preceded with the transitional phrase “including,” it is understood that we also contemplate the same composition or group of elements with transitional phrases “consisting essentially of,” “consisting of,” “selected from the group of consisting of,” or “is” preceding the recitation of the composition, element, or elements and vice versa. The processes or apparatuses disclosed herein suitably may be practiced in the absence of any element which is not specifically disclosed herein.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A process for producing a catalyst composition, the process comprising:
mixing a catalyst compound having a transition metal atom, a support, and optionally an activator, to form a supported catalyst mixture; and
drying the supported catalyst mixture at a pressure of about 10 kPa or less and a temperature of about 60° C. or greater for a period of about 6 hours or less, wherein aliphatic hydrocarbon is not introduced to the supported catalyst mixture after drying.

2. The process of claim 1, consisting of: (a) mixing the catalyst compound, the support, and optional activator to form the supported catalyst mixture; (b) drying the supported catalyst mixture; and (c) obtaining the catalyst composition.

3. A catalyst composition comprising:
a catalyst compound having a transition metal atom;
an aluminum activator; and
a support,
wherein the catalyst composition has from about 0.5 wt % to about 1.5 wt % aromatic hydrocarbon; and
wherein the catalyst composition has less than 1 wt % of aliphatic hydrocarbon.

4. The catalyst composition of claim 3, wherein the catalyst composition is made by a process comprising:
mixing a catalyst compound having a transition metal atom, a support, and optionally an activator, to form a supported catalyst mixture; and
obtaining the catalyst composition by drying the supported catalyst mixture at a pressure of about 10 kPa or less and a temperature of about 60° C. or greater for a period of about 6 hours or less, wherein aliphatic hydrocarbon is not introduced to the catalyst compound after drying.

5. A process for producing polyolefins, the process comprising:
introducing a catalyst composition and at least one olefin to a polymerization reactor,
wherein the catalyst composition comprises:
a catalyst compound having a transition metal atom,
an aluminum activator, and
a support;
wherein the catalyst composition has:
about 0.5 wt % to about 1.5 wt % aromatic hydrocarbon content, and
less than 1 wt % of aliphatic hydrocarbon content; and
obtaining a polyolefin having about 300 ppb or less aromatic hydrocarbon.

6. The process of claim 5, wherein the catalyst composition has about 1.2 wt % or less toluene.

7. The process of claim 5, wherein the catalyst composition has about 1.2 wt % or less aromatic hydrocarbon content.

8. The process of claim 7, wherein the catalyst composition has about 0.8 wt % or more aromatic hydrocarbon content.

9. The process of claim 5, wherein the polyolefin has an aluminum content of about 1 ppm to about 5 ppm.

10. The process of claim 5, wherein the polyolefin has a silica content of about 50 ppm or greater.

11. The process of claim 5, further comprising extruding the polyolefin to form a polyolefin film having one or both of the following properties:
a toluene concentration of about 0.05 mg/m² or less; and
a weight percent of aluminum of about 0.01 wt % or greater.

12. The process of claim 5, wherein the catalyst compound is selected from the group consisting of:
bis(1-methyl, 3-n-butyl cyclopentadienyl) zirconium dichloride;
dimethylsilyl bis(tetrahydroindenyl) zirconium dichloride;
bis(n-propylcyclopentadienyl) hafnium dimethyl;
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H)₂C(tetramethylcyclopentadienyl)(1-cyclododecylamido)M(R)₂; and
μ-(CH₃)₂Si(η⁵-2,6,6-trimethyl-1,5,6,7-tetrahydro-s-indacen-1-yl)(tertbutylamido)M(R)₂;
wherein M is selected from Ti, Zr, and Hf; and R is selected from halogen or C1 to C5 alkyl.

13. The process of claim 12, wherein the activator is selected from the group consisting of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetra(perfluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-diethylanilinium tetrakis(perfluoronaphthyl)borate, N,N-dimethyl-(2,4,6-trimethylanilinium) tetrakis(perfluoronaphthyl)borate, and tropillium tetrakis(perfluoronaphthyl)borate.

14. The process of claim 13, wherein the support is selected from the group consisting of Al₂O₃, ZrO₂, SiO₂, SiO₂/Al₂O₂, silica clay, and mixture(s) thereof.

15. The process of claim 5, wherein the at least one olefin comprises ethylene, and the polymerization reactor is a gas phase polymerization reactor.

16. The process of claim 15, wherein the polyolefin has an aluminum content of about 5 ppm or less.

17. The process of claim 15, wherein the polyolefin has a silica content of about 200 ppm or less.

18. The process of claim 15, further comprising obtaining a polyethylene resin having:
a toluene content of about 300 ppb or less;
an aluminum content of about 5 ppm or greater; and
a silica content of about 50 ppm or greater.

19. The process of claim 18, wherein the polyethylene resin further has:
a Mw of from about 15,000 g/mol to about 2,000,000 g/mol;
a Mn of from about 2,500 g/mol to about 2,500.00 g/mol;
a MI of from about 0.2 g/10 min to about 1.5 g/10 min (190° C./2.16 kg);
a PDI of from about 1 to about 3;
a g′vis of about 0.85 or greater; and
a density of from about 0.91 to about 0.93.
